(19) United States
(12) Patent Application Publication
(10) Pub. No.: US 2026/0259656 A1
(43) Pub. Date: Sep. 3, 2026

(54) DISPLAY APPARATUS AND ANIMATION DISPLAY METHOD FOR DISPLAY APPARATUS

(71) Applicant: HISENSE VISUAL TECHNOLOGY CO., LTD., Qingdao (CN)

(72) Inventors: Mengjie WANG, Qingdao (CN); Shuo ZHU, Qingdao (CN); Luming YANG, Qingdao (CN); Yongjiang SUN, Qingdao (CN); Can HE, Qingdao (CN); Shanjuan BAO, Qingdao (CN)

(21) Appl. No.: 19/656,205

(22) Filed: Apr. 23, 2026

Related U.S. Application Data
(63) Continuation of application No. PCT/CN2024/112869, filed on Aug. 16, 2024.

(30) Foreign Application Priority Data
Oct. 25, 2023 (CN) 202311393773.6
Oct. 25, 2023 (CN) 202311393817.5

(51) Int. Cl. G06F 3/04847; G06F 3/04817; G06F 3/04845; G06F 3/14; G06T 7/00

(52) U.S. Cl. CPC G06F 3/04847; G06F 3/04817; G06F 3/04845; G06F 3/14; G06T 7/0002; G06T 2200/24; G06T 2207/10024; G06T 2207/30168; G06T 2210/22

(57) ABSTRACT

A display apparatus and an animation display method for a display apparatus are provided. The display apparatus includes at least one processor configured to execute computer instructions to cause the display apparatus to perform: providing a first layer and a second layer, where the first layer displays a first interface, and the second layer displays a second interface; based on that the second interface is displayed in the second layer on the display, in response to a play command input by a user for playing media source data, obtaining play status information; generating a shared element image based on the play status information and a first animation image; generating a transition animation based on the shared element image, and controlling the display to display the transition animation in the second layer; controlling the display to display the first interface in the first layer after the transition animation display is completed.

### CROSS-REFERENCE OF RELATED APPLICATIONS

The present application is a continuation application of PCT Application No. PCT/CN2024/112869, filed on Aug. 16, 2024, which claims the priorities to Chinese Patent Application No. 202311393817.5, filed on Oct. 25, 2023, and No. 202311393773.6, filed on Oct. 25, 2023, all of which are incorporated herein by reference in their entirety.

### FIELD OF INVENTION

The present application relates to display apparatus, and particularly relates to a display apparatus and an animation display method for the display apparatus.

### BACKGROUND

Display apparatuses are intelligent devices that can present a user interface and support user interaction. Taking smart TVs as an example, smart TVs are television products that are based on Internet application technology, have an open operating system and chip, have an open application platform, can realize two-way human-computer interaction, and integrate multiple functions such as audio-visual, entertainment, and data to meet the diverse and personalized needs of users.

Display apparatuses can form a user interface by overlaying multiple layers. For example, the display layers of a display apparatus can include a video layer and a graphics layer. The video layer can have a better image display effect and can be used to display the play image of images or videos; the graphics layer has a better display response speed and dynamic effects and can be used to display thumbnails and transition animations.

However, because the video layer and the graphics layer process the displayed images differently, there is a large discrepancy between the thumbnails, transition animations, and the content displayed on the play image. For example, the thumbnail is displayed as a rounded square, while the play image has multiple scaling modes, such as original size, original ratio, and full-screen. The shapes of the play images are different in different scaling modes. When the display image transitions from the preview interface to the play interface, the inconsistency between the shapes of the thumbnail and the play image will cause the transition animation to be uncoordinated and affect the transition effect.

### BRIEF SUMMARY

A display apparatus according to some embodiments of the present application can include: a display; a memory, configured to store computer instructions and data associated with the display apparatus; at least one processor, communicatively connected to the display and the memory; where the at least one processor is configured to execute the computer instructions to cause the display apparatus to perform:
providing a first layer and a second layer, where the first layer is a video layer configured to display a first interface presenting a media source play image processed via an image quality processing, and the second layer is an On Screen Display (OSD) layer configured to display a second interface presenting a media source icon image; different image quality processings are performed on displayed image content in the first layer and displayed image content in the second layer;
based on that the second interface is displayed in the second layer on the display, in response to a play command input by a user for playing media source data, obtaining play status information; where the play status information includes an image quality processing parameter of the first layer;
generating a shared element image based on the play status information and a first animation image, where the first animation image is a thumbnail icon of the media source data or a cover image associated with the media source data; and an aspect ratio of the shared element image is equal to an aspect ratio of a pre-played image of the media source data in the first layer;
generating a transition animation based on the shared element image, and controlling the display to display the transition animation in the second layer;
controlling the display to display the first interface in the first layer after the transition animation display is completed, where the first interface presents a media source play image processed via an image quality processing corresponding to the image quality processing parameter.

An animation display method for a display apparatus according to some embodiments of the present application, the display apparatus includes a display configured to display a first layer and a second layer, the first layer is a video layer configured to display a first interface presenting a media source play image processed via an image quality processing, and the second layer is an On Screen Display (OSD) layer configured to display a second interface presenting a media source icon image; different image quality processings are performed on displayed image content in the first layer and displayed image content in the second layer; where the method includes:
based on that the second interface is displayed in the second layer on the display, in response to a play command input by a user for playing media source data, obtaining play status information; where the play status information includes an image quality processing parameter of the first layer;
generating a shared element image based on the play status information and a first animation image, where the first animation image is a thumbnail icon of the media source data or a cover image associated with the media source data; and an aspect ratio of the shared element image is equal to an aspect ratio of a pre-played image of the media source data in the first layer;
generating a transition animation based on the shared element image, and controlling the display to display the transition animation in the second layer;
controlling the display to display the first interface in the first layer after the transition animation display is completed, where the first interface presents a media source play image processed via an image quality processing corresponding to the image quality processing parameter.

### BRIEF DESCRIPTION OF THE DRAWINGS

FIG. 1 is a schematic diagram of an operation scenario between a display apparatus and a control device according to some embodiments of the present application.

FIG. 2 is a hardware configuration block diagram of a display apparatus according to some embodiments of the present application.

FIG. 3 is a hardware configuration block diagram of a control device according to some embodiments of the present application.

FIG. 4 is a schematic diagram of software configuration in a display apparatus according to some embodiments of the present application.

FIG. 5 is a schematic diagram of display function modules according to some embodiments of the present application.

FIG. 6 is a schematic diagram of the relationship between the video layer and the OSD layer according to some embodiments of the present application.

FIG. 7 is a schematic diagram showing the relationship between the acceleration layer and the OSD layer according to some embodiments of the present application.

FIG. 8A is a schematic diagram of the difference effect of the transition animation according to some embodiments of the present application.

FIG. 8B is a schematic diagram of the multi-layer display difference effect according to some embodiments of the present application.

FIG. 9 is a schematic diagram of the display preview interface according to some embodiments of the present application.

FIG. 10 is a schematic diagram of the multi-layer display effect according to some embodiments of the present application.

FIG. 11 is a schematic diagram of the play process transition animation display flow according to some embodiments of the present application.

FIG. 12 is a schematic diagram of the transition animation display process when playing media sources according to some embodiments of the present application.

FIG. 13 is a comparison diagram of thumbnails and play image ratios according to some embodiments of the present application.

FIG. 14 is a schematic diagram of shared element images according to some embodiments of the present application.

FIG. 15 is a schematic diagram of the generated transition animation effect according to some embodiments of the present application.

FIG. 16 is a schematic diagram of the vertical display image transition animation effect according to some embodiments of the present application.

FIG. 17 is a schematic diagram of the transition animation display process when exiting media source play according to some embodiments of the present application.

FIG. 18 is a schematic diagram of the transition animation display effect when exiting media source play according to some embodiments of the present application.

FIG. 19 is a schematic diagram of a method for cropping shared element images according to some embodiments of the present application.

FIG. 20 is a schematic diagram of the transition animation display process for exiting play according to some embodiments of the present application.

FIG. 21 is a schematic diagram showing the scaling process according to some embodiments of the present application.

FIG. 22 is a schematic diagram showing the scaling process according to some embodiments of the present application.

### DETAILED DESCRIPTION OF THE EMBODIMENTS

Embodiments will now be described in detail, examples of which are illustrated in the accompanying drawings. When the following description refers to the accompanying drawings, unless otherwise indicated, the same numbers in different drawings represent the same or similar elements. Embodiments described in the following examples do not represent all embodiments consistent with the present application. These are merely examples of systems and methods consistent with some aspects of the present application as detailed in the claims.

It should be noted that the brief descriptions of terms in the present application are only for the purpose of facilitating the understanding of the embodiments described below, and are not intended to limit the embodiments of the present application. Unless otherwise stated, these terms should be understood in their ordinary and common sense.

The terms “first,” “second,” “third,” etc., used in the specification, claims, and drawings of the present application are used to distinguish similar or related objects or entities, and do not necessarily imply a specific order or sequence, unless otherwise specified. It should be understood that such terms can be used interchangeably in appropriate situations.

The terms “comprising” and “including”, and any variations thereof, are intended to cover but not exclude inclusion, for example, a product or device that includes a range of components is not necessarily limited to all of the components that are clearly listed, but can include other components that are not clearly listed or that are inherent to such product or device.

The term “module” refers to any known or subsequently developed hardware, software, firmware, artificial intelligence, fuzzy logic, or combination of hardware and/or software code that is capable of performing the functions associated with that element.

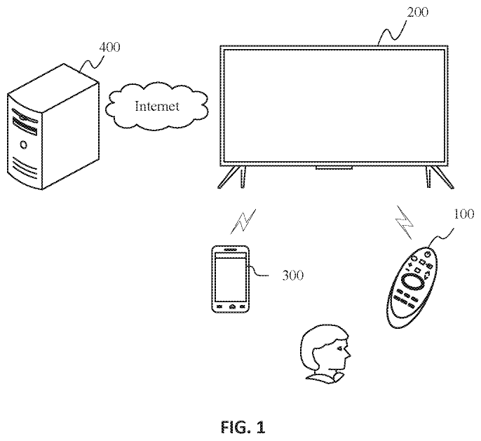

FIG. 1 is a schematic diagram of an operation scenario between a display apparatus and a control device according to some embodiments of the present application. As shown in FIG. 1, the user can operate the display apparatus 200 through the mobile terminal 300 and the control device 100.

In some embodiments, the mobile terminal 300 can install software applications with the display apparatus 200 to achieve connection and communication through network communication protocols, thereby realizing one-to-one control operation and data communication. The audio and video content displayed on the mobile terminal 300 can also be transmitted to the display apparatus 200 to achieve synchronous display.

As shown in FIG. 1, the display apparatus 200 can also communicate with the server 400 via various communication methods. It allows the display apparatus 200 to communicate via a local area network (LAN), a wireless local area network (WLAN), and other networks.

In addition to providing broadcast television reception functions, the display apparatus 200 can also be equipped with intelligent network television functions that provide computer support, including but not limited to network television, smart television, Internet Protocol television (IPTV), etc.

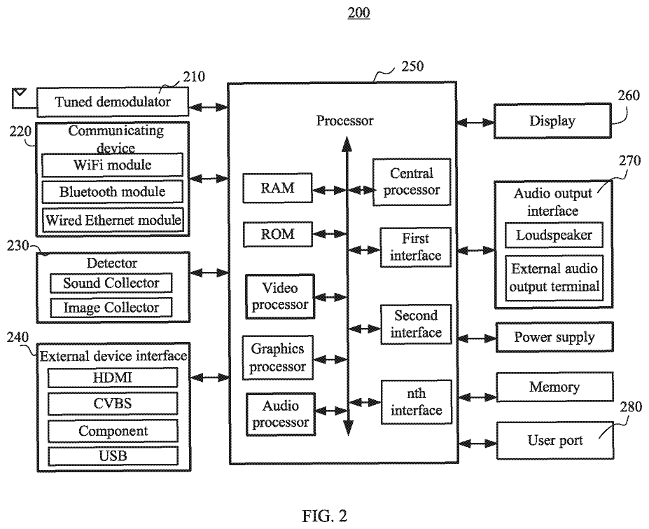

FIG. 2 is a hardware configuration block diagram of a display apparatus according to some embodiments of the present application.

In some embodiments, the display apparatus 200 can include at least one of a tuned demodulator 210, a communication device 220, a detector 230, a device interface 240, at least one processor 250, a display 260, an audio output interface 270, a memory, a power supply, and a user interface.

In some embodiments, the detector 230 can be used to collect signals from the external environment or signals interacting with the outside world. For example, the detector 230 can include a light receiver, which can be used to collect ambient light intensity; or, the detector 230 can include an image acquisition device, such as a camera, which can be used to collect external environmental scenes, user attributes, or user interaction gestures; or, detector 230 can include a sound acquisition device, such as a microphone, which can be used to receive external sounds.

In some embodiments, the display 260 can include a display screen component for presenting images, and a driving component for driving image display, which can be used to receive image signals from at least one processor, and to display video content, image content, menu control interface, and user control UI interface, etc.

In some embodiments, the communication device 220 is a component that can be used to communicate with external devices or the server 400 according to various communication protocol types.

In some embodiments, at least one processor 250 can include a central processing unit, a video processor, an audio processor, a graphics processor, RAM, ROM, a first interface to an nth interface for input/output, and at least one processor 250 can control the operation of the display apparatus and respond to user operations through various software control programs stored in the memory. At least one processor 250 can control the overall operation of the display apparatus 200.

In some embodiments, at least one processor 250 and the tuned demodulator 210 can be located in different separate devices, that is, the tuned demodulator 210 can also be located in an external device of the main device where at least one processor 250 is located, such as an external set-top box.

In some embodiments, a user can input user commands through a graphical user interface (GUI) displayed on a display 260, and the user input interface receives user input commands through the graphical user interface (GUI).

In some embodiments, the user interface 280 is an interface that can be used to receive control input.

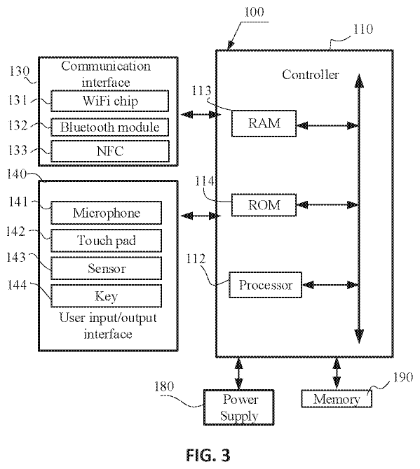

FIG. 3 is a hardware configuration block diagram of a control device according to some embodiments of the present application. As shown in FIG. 3, the control device 100 can include a control unit 110, a communication interface 130, a user input/output interface 140, a memory 190, and a power supply 180.

The control device 100 can be configured to control the display apparatus 200, and can receive user input operation commands and convert the operation commands into commands that the display apparatus 200 can recognize and respond to, thus acting as an intermediary for interaction between the user and the display apparatus 200.

In some embodiments, the control device 100 can be a smart device. For example, the control device 100 can be installed with various applications of control display apparatus 200 according to user needs.

In some embodiments, as shown in FIG. 1, a mobile terminal 300 or other smart electronic device can perform similar functions to the control device 100 after installing an application that controls the display apparatus 200.

The control device 110 can include a processor 112, RAM 113 and ROM 114, a communication interface 130, and a communication bus. The control device 110 can be used to control the operation and function of the control equipment 100, as well as the communication and cooperation between internal components and the external and internal data processing functions.

Under the control of the control device 110, the communication interface 130 can realize the communication of control signals and data signals with the display apparatus 200. The communication interface 130 can include at least one of other near-field communication modules such as WiFi chip 131, Bluetooth module 132, NFC module 133, etc.

User input/output interface 140, where the input interface can include at least one of other input interfaces such as microphone 141, touch pad 142, sensor 143, button 144, etc.

In some embodiments, the control device 100 can include at least one of a communication interface 130 and an input/output interface 140. The control device 100 can be configured with a communication interface 130, such as WiFi, Bluetooth, NFC, etc., which can encode user input commands through WiFi, Bluetooth, or NFC protocols and send them to the display apparatus 200.

The memory 190 can be used to store various operating programs, data and applications that drive and control the control device 100 under the control of the control device 110. The memory 190 can store various control signal commands input by the user.

The power supply 180 can be used to provide operating power support for each component of the control device 100 under the control of the control device 110.

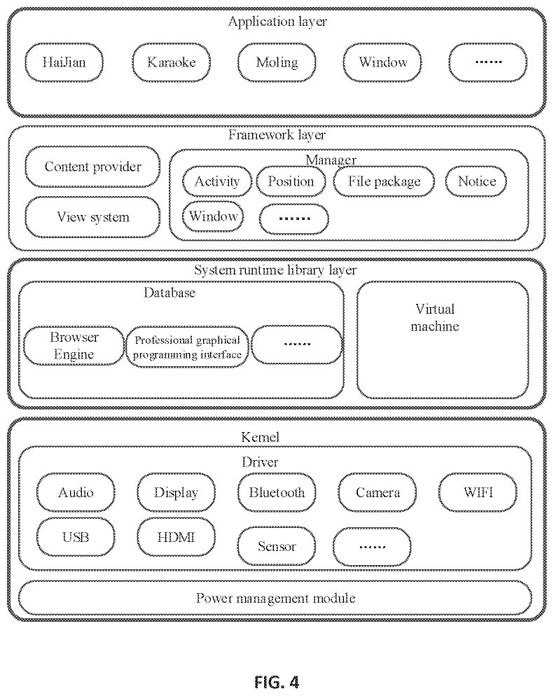

FIG. 4 is a schematic diagram of software configuration in a display apparatus according to some embodiments of the present application. As shown in FIG. 4, in some embodiments, the system can be divided into four layers, from top to bottom: the Applications layer (hereinafter referred to as the “Application Layer”), the Application Framework layer (hereinafter referred to as the “Framework Layer”), the Android runtime and system library layer (hereinafter referred to as the “System Runtime Library Layer”), and the kernel layer.

In some embodiments, at least one application can run in the application layer. These applications can be Windows programs, system settings programs, or clock programs that come with the operating system; or they can be applications developed by third-party developers. In practice, the application packages in the application layer are not limited to the examples above.

The framework layer can provide application programming interfaces (APIs) and programming frameworks for applications. The application framework layer can include some predefined functions. The application framework layer acts as a processing center, which determines the actions taken by the applications in the application layer. Applications can access system resources and obtain system services during execution through API interfaces.

As shown in FIG. 4, the application framework layer in this embodiment can include a view system, managers, content providers, etc. The view system can design and implement the application's interface and interaction, and can include lists, grids, text boxes, buttons, etc. The manager can include at least one of the following modules: Activity Manager, which can be used to interact with all activities running on the system; Location Manager, which can be used to provide system services or applications with access to system location services; Package Manager, which can be used to retrieve various information related to application packages currently installed on the device; Notification Manager, which can be used to control the display and clearing of notification messages; and Window Manager, which can be used to manage icons, windows, toolbars, wallpapers, and desktop widgets on the user interface.

In some embodiments, the activity manager can be used to manage the lifecycle of individual applications and common navigation back functions, such as controlling application exit, opening, and back actions. The window manager can be used to manage all window programs, such as getting the screen size, determining whether there is a status bar, locking the screen, capturing the screen, and controlling changes to the display window (such as shrinking the display window, shaking the display, distorting the display, etc.)

In some embodiments, the system runtime library layer can provide support for the upper layer, namely the framework layer. When the framework layer is used, the Android operating system will run the C/C++ libraries contained in the system runtime library layer to implement the functions to be implemented by the framework layer.

In some embodiments, the kernel layer is a layer between hardware and software. As shown in FIG. 4, the kernel layer can include at least one of the following drivers: audio driver, display driver, Bluetooth driver, camera driver, WIFI driver, USB driver, HDMI driver, sensor driver (such as fingerprint sensor, temperature sensor, pressure sensor, etc.), and power driver, etc.

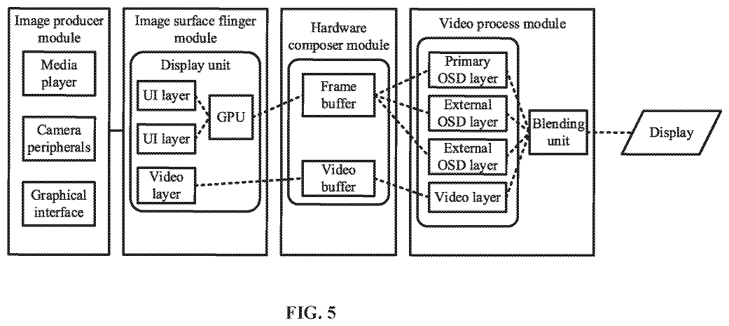

Based on the above system hierarchy, the display apparatus 200 can call resources at each layer to form a display image on the display 260, thereby controlling the display 260 to display the user interface. In order to display the user interface, the display apparatus 200 can be configured with functional modules related to the display process. For example, as shown in FIG. 5, the display apparatus 200 can render and display the user interface in real time through an image producer module, an image surface flinger module, a composer module, a video processing unit (VPU) hardware module, and a screen.

During the display process, peripherals such as the graphics interface (OpenGLES) of the image producer module, the media player, and the camera can be used to generate the image content to be displayed and pass the image content to the image surface flinger module. The image surface flinger module can be used to control the content displayed on the display 260, that is, the image content can be rendered through the user interaction layer (UI layer) or the video layer according to the image content.

To achieve better display results, the image content of the UI layer can be rendered by GPU components, thereby forming screen frames for display in the composer module. The composer module can store frame frames through frame buffers and video buffers, and the video processing module can generate the image content on the corresponding layers. In other words, the image frames generated during video play form the image content through the video plane, while the image frames of other image screens (such as UI interface graphics) form the image content through the primary OSD (On-Screen Display) plane. Finally, the display apparatus 200 can form the final image through the blending unit of the video process module and display it on the display 260.

During the process of displaying the user interface, the display apparatus 200 switches between multiple interfaces based on the user's input interaction. For example, during media source play, the display apparatus 200 can switch between the preview interface and the play interface. The preview interface can be used to display a list of media sources, meaning that the preview interface can include at least one media source data icon. The play interface can be used to display the play image of media source data; therefore, the play interface can be displayed in full-screen or fill the entire window. When the preview interface is displayed on the display apparatus 200, the user can click the media source data icon on the preview interface using a remote control or other control device to input play commands. After receiving a media source play command input by the user, the display apparatus 200 can control the play of the clicked media source data and switch to the play interface.

It should be noted that, in some embodiments of the application, the two user interfaces that the display apparatus 200 can use for interface switching are referred to as the first interface and the second interface. When one of the first interface and the second interface serves as the user interface before the switch, the other serves as the user interface after the switch. For example, if the first interface is the play interface and the second interface is the preview interface, then when the play process begins, the display apparatus 200 switches from displaying the second interface to displaying the first interface. When exiting the play process, the display apparatus 200 switches from displaying the first interface to displaying the second interface. In some embodiments of the application, the first interface is used as the play interface and the second interface is used as the preview interface as examples for description. It should be understood that the first interface and the second interface can also be used to represent other interfaces respectively. In addition, the video layer and OSD layer can display different user interfaces, or they can be overlaid to display a single user interface.

In some embodiments, different user interfaces displayed by the display apparatus 200 can be displayed through different layers, or multiple layers can be superimposed on each other, with different layers having different display modes. The display apparatus 200 can display the first interface and the second interface through the video layer and the OSD layer, respectively. The video layer can establish a connection with the media source player in the image producer module to display the image content generated by the media player through playing media source data. For example, when the display apparatus 200 plays video media sources, the media source player can parse the media source data to form multiple frames of media source images, and send the multiple frames of media source images to the video layer to form a video play image.

The video layer can display images based on the content, format, type, decoding specifications, and image quality parameters of media source data, thereby achieving better image display effects. For example, for high frame rate video media sources of 90 Hz, the media player of the display apparatus 200 can directly obtain 90 frames of display images per second by decoding the video data and present these 90 frames of display images in the video layer.

It should be noted that the video layer can be used not only to display video-type media sources, but also to display other types of media sources. For example, the video layer can also display image details to users. That is, image media source data can be decoded by the media player to form multiple frames of the same content, and displayed in the video layer according to the display refresh rate of 260.

In some embodiments, the display apparatus 200 can also perform image quality processing on the image content when displaying the image content in the video layer, so that the image content displayed in the video layer better meets the user's needs. For example, the operating system of the display apparatus 200 can preset multiple image quality mode options, including standard, soft, vivid, eye protection, etc. Users can select one of the image quality modes according to their viewing needs, and the display apparatus 200 can process the image quality of the displayed content according to the selected image quality mode. For example, when a user selects the vivid mode, the display apparatus 200 can enhance the color saturation and brightness of the image content, making the image content more vivid and bright, and then display the screen frames with adjusted image quality through the video layer.

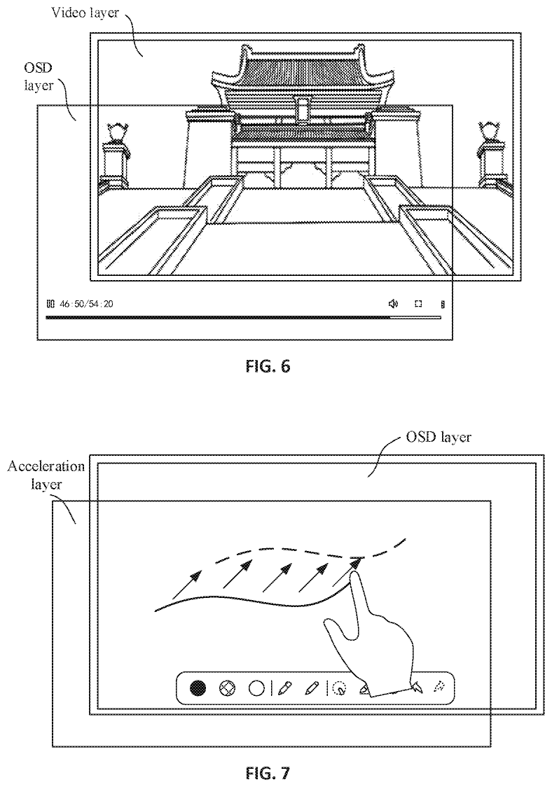

The OSD layer can refresh and display image-related information in real time based on the interactive operation process of the display apparatus 200. For example, the image-related information can include graphics, text, and icons, etc. The OSD layer can also display specific device status information. For example, OSD can be used to display information such as channel, volume, brightness, and contrast. As shown in FIG. 6, the OSD layer can be displayed at a higher level than the video layer, allowing the graphics and other content displayed by the OSD layer to appear on the video play image, so that users can perform interactive operations based on the content displayed by the OSD layer.

Since the OSD layer needs to respond to user interactions in real time, and the dynamic display effect of the OSD is better than the dynamic display effect of the video layer. In some embodiments, the display process of the display apparatus 200 can be completed by the cooperation of the video layer and the OSD layer. For example, when a user clicks on an image icon (thumbnail) in the image list interface to control the display apparatus 200 to display the clicked image in full-screen, the display apparatus 200 first displays the image thumbnail icon through the OSD layer. After the user clicks the thumbnail icon, the display apparatus 200 displays a transition animation for full-screen display of the image through the OSD layer, also known as a transition animation. After the transition animation is completed, the display apparatus 200 then displays the image content through the video layer.

It should be noted that during the display of the user interface in the OSD layer, the graphics, text, icons, and other content presented by the OSD layer are related to the media sources displayed in the video layer. For example, the image thumbnail icons presented by the OSD layer are graphics generated by the display apparatus 200 after thumbnail sampling and scaling of the image content.

For some display apparatuses 200 that require real-time response to interactive content, in order to present a better real-time response effect, the display apparatus 200 should shorten the delay between the input time of the interactive action and the display time of the image display result. Therefore, in some embodiments, the display apparatus 200 can present a real-time display effect by setting an acceleration layer. That is, in the video process module of the display apparatus 200, an additional extended display layer (external OSD plane) can be set on the basis of the primary OSD layer and the video layer. Among them, the extended display layer can be configured with different layer characteristics according to specific display effect requirements. For example, the bitmap refresh mode of the extended display layer can be modified to refresh the extended display layer in real time according to the region, thereby improving the display speed of the graphics. In this case, the extended display layer can be used as an acceleration layer in scenarios with high dynamic display effects.

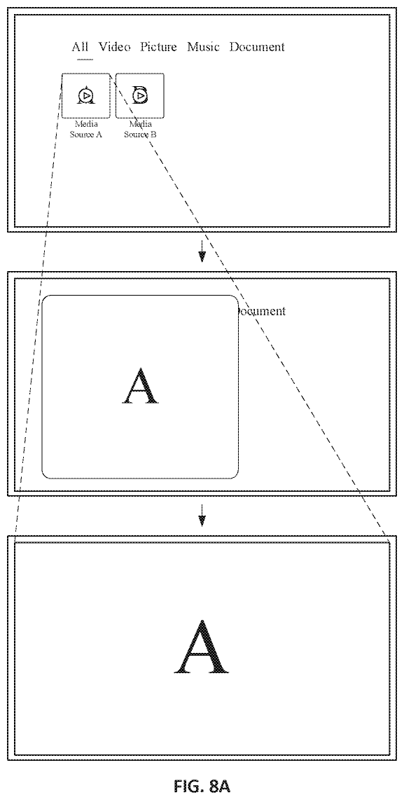

Taking a whiteboard application running on a display apparatus 200 that supports touch interaction as an example, in order to improve the real-time response speed of the line drawing process, the touch trajectory can be drawn in real time on the extended display layer (acceleration layer) after the user's touch operation is detected. As shown in FIG. 7, the display level of the acceleration layer can be higher than that of other layers. When the user completes the touch input, the lines drawn by the acceleration layer are updated to other layers, thereby reducing input delay and improving the real-time display effect of the whiteboard application drawing process.

It should be noted that the extended display layer, as an auxiliary display layer, can be controlled to show and hide at any time based on the actual interaction process. For example, when the extended display layer is used as an acceleration layer to assist the user in real-time display of touch trajectory, the display apparatus 200 can control it to be displayed when the user inputs a touch interaction operation and hidden when the user does not input a touch interaction operation. The display apparatus 200 can listen to touch interaction events input by the user. When a down event is detected in the user's touch interaction, the acceleration layer is enabled and displayed; when an up event is detected in the user's touch interaction, the acceleration layer is disabled and hidden. In some embodiments, the display apparatus 200 can also control the display and hiding of the extended display layer according to the application running status. For example, when it is detected that the display apparatus 200 starts running a touch-interactive application such as a whiteboard, the acceleration layer is enabled and displayed; when it is detected that the display apparatus 200 exits the touch-interactive application such as a whiteboard, the acceleration layer is disabled and hidden.

In some embodiments, in order to obtain a better display effect, the display apparatus 200 can add a transition animation between the first interface and the second interface during the process of switching from the second interface to the first interface (or from the first interface to the second interface) when switching user interfaces. For example, Android-based display apparatuses 200 can obtain transition animations by setting shared element animations. Among them, the Android system platform can provide transition animations between multiple Activities, and the shared element animation is one type of transition animation. Starting with Android 5.0, the shared element animations are supported. Shared element animations allow two Activities to share certain controls (i.e., shared elements) when transitioning from Activity A to Activity B, and generate transition animations based on these shared elements. It should be noted that the sharing here is not true sharing, but rather that when navigating from Activity A to Activity B, elements marked as shared will have an animated scaling effect. The scaling effect also applies when you close Activity B and return to Activity A.

Furthermore, according to the Android source code, the shared element animation renders the ShareElementView to the top layer of the entire Activity (the ViewOverlay of DecorView). The ShareElementView cannot be obscured when generating transition animations. Throughout the entire ShareElement animation process (Activity A turns on Activity B), only the ShareElement in Activity B performs the animation. The sole purpose of the ShareElement in Activity A is to provide parameters such as position and size. These parameters are then set on the corresponding View in Activity B within the setSharedElementState( ) function, creating the transition animation effect.

During the process of generating transition animations, the display apparatus 200 can use one or more display contents from the first interface or the second interface as shared elements for generating transition animations. For example, when the display apparatus 200 switches from the preview interface to the play interface, the display apparatus 200 can extract the media source data icons (such as thumbnails) in the preview interface as shared elements, and enlarge the thumbnails frame by frame through multiple animation frames. When the thumbnail is the same size as or close to the size of the play image, a transition animation of the thumbnail gradually enlarging is generated and displayed. Similarly, when the display apparatus 200 switches from the play interface to the preview interface, the display apparatus 200 can extract the display image (such as the current play frame) in the play interface as a shared element, and gradually shrink the display image frame by frame through multiple animation frames until the size of the display image is the same as or similar to the size of the icon in the preview interface, generate a transition animation of the display image gradually shrinking, and display it.

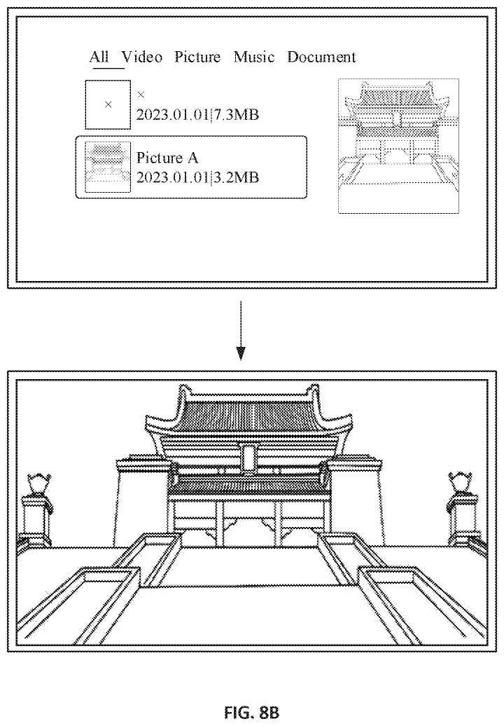

However, since the first interface and the second interface have different interface types and different interface elements, when a transition animation is generated based on the interface elements in the first interface or the second interface as shared elements, the transition animation differs greatly from the content displayed in the user interface after the switch. For example, as shown in FIG. 8A, the thumbnail is displayed as a rounded square, while the play image has multiple scaling modes, such as original size, original ratio, and full-screen. The shape of the play image is different under different scaling modes. When the display image transitions from the preview interface to the play interface, the inconsistency between the shapes of the thumbnail and the play image will cause the transition animation to be uncoordinated and affect the transition effect.

Furthermore, when the first interface and the second interface are displayed through different layers, since different layers can be configured to complete the display of the image in different ways, the display apparatus 200 can have differences in image quality due to the change of layers during the display process. For example, as shown in FIG. 8B, during the full-screen display of an image, the display apparatus 200 displays the image in full-screen through the video layer, while the thumbnail and transition animation before full-screen display are displayed through the OSD layer. Since the video layer can adjust the image quality content according to the image quality mode of the display apparatus 200, while the OSD layer directly renders the interface according to the graphical controls, there is a display effect difference between the displayed thumbnail and the transition animation generated based on the image and the full-screen image. When a user sets the vivid mode, the full-screen image can undergo color saturation and brightness processing, while the thumbnail and transition animation images cannot undergo color saturation and brightness processing. This results in inconsistent display effects of the image content in different layers, with the same image content exhibiting abrupt changes in display parameters such as image quality, color, and contrast. For example, in vivid mode, the video layer displays the image in full-screen with a color saturation of 100%, a brightness of 80, and a contrast of 60. The OSD layer still displays thumbnails in standard mode with color saturation of 50%, brightness of 50, and contrast of 50. As a result, the images displayed in the video layer and the OSD layer exhibit abrupt changes in display parameters such as color saturation, brightness, and contrast.

To alleviate the problem of large differences in display effects when displaying images through different layers in a display apparatus 200, some embodiments of the present application provide an animation display method for a display apparatus, mainly for multi-layer display. The method can be applied to display apparatuses 200 such as televisions. To implement the method, the display apparatus 200 can include at least a display 260, a memory, and at least one processor 250. The display 260 can be configured to display a first interface and/or a second interface, the memory can be configured to store computer instructions and data associated with the display apparatus 200, and at least one processor 250 can be configured to execute the computer instructions to cause the display apparatus to perform the program steps corresponding to the animation display method.

In some embodiments, the memory included in the display apparatus 200 is further configured to store image quality processing parameters associated with the first layer and/or the second layer.

The first interface can be displayed in the first layer, and the second interface can be displayed in the second layer. The first layer and the second layer are two different display layers that can have different uses. The first layer and the second layer can perform different image quality processing on the displayed image content. For example, the first layer is the video layer, which can be used to display the play interface, and the second layer is the OSD layer, which can be used to display the preview interface.

In some embodiments of the application, the first layer is a video layer used to display the play interface or images, and the second layer is an OSD layer used to display the preview interface or image thumbnails. This is used as an example to illustrate the animation display method. It should be understood that the first layer and the second layer can also be used as other types of layers.

The first layer can be used to display interface content or media source data according to the image quality mode set by the display apparatus 200. For example, the first layer is the video layer of the display apparatus 200, which can be used to form the play image in the user interface. When the user sets the image quality mode of the display apparatus 200 to “Vivid Mode”, the display apparatus 200 can adjust the color saturation and brightness of the image according to the image quality mode, and then display it through the first layer.

Corresponding to the first layer, the second layer can be used to display interface content or media source data according to the standard image quality mode. For example, the second layer is the OSD layer, which can be used to display application interfaces, application menus, toolbars, and other content. Since the application interface, application menu, toolbar and other content are often hidden during the play of media source data on the display apparatus 200, the OSD layer will not display content according to the image quality mode of the display apparatus 200.

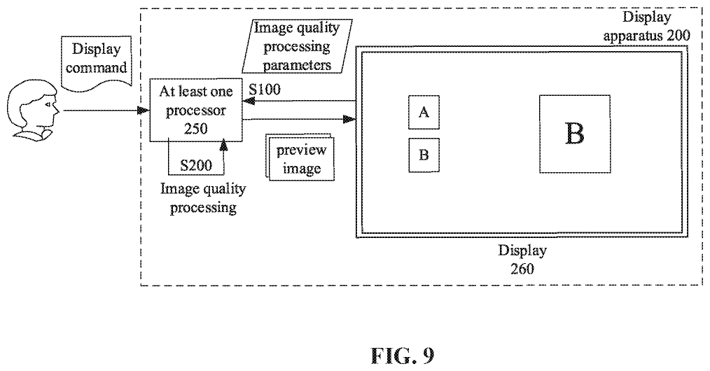

Since multi-layer display can occur in a variety of application scenarios, it can include scenarios such as entering the preview interface, play scenarios, play animation switching (turning on transitions), stopping play scenarios, stopping play animation switching (turning off transitions), and scaling scenarios. Different application scenarios can be triggered by different control commands. The following describes the multi-layer display process using different application scenarios as examples. For scenarios entering the preview interface, as shown in FIG. 9, it can include some or all of the following operations.

S100: in response to a user-inputted display command for displaying the preview interface, obtain the image quality processing parameter of the first layer.

Display commands for the preview interface can be input via control device 100 (remote control), touch interaction, voice interaction, and external devices such as a mouse. For example, a user can use the remote control that comes with the display apparatus 200 to control the focus cursor to select the “File Manager-All Files (or Images, Videos)” option in the user interface in sequence, and the display apparatus 200 can then jump to the display preview interface. For example, users can input the voice command “Show image preview interface” through a voice interaction application to control the display apparatus 200 to jump to the preview interface.

The preview interface can include at least one media source icon displayed in thumbnail form. Since the thumbnail is an image content displayed based on the OSD layer, its display effect is generally not affected by the image quality mode set by the display apparatus 200. Therefore, the thumbnail display pattern is the effect without image quality mode adjustment. For example, a thumbnail is a smaller image created by scaling or compressing the original image. When an image is clicked to display in full-screen, it is displayed through the video layer. When the display apparatus 200 is set to vivid mode, the image displayed in full-screen is the effect after adjusting the colors in vivid mode. At this point, the display effect of the thumbnail is quite different from that of the full-screen image.

To mitigate the difference in the display effect of the same image between the preview interface and the full-screen display interface, the display apparatus 200 can obtain the image quality processing parameters of the first layer after receiving the display command input by the user for displaying the preview interface. Among them, the image quality processing parameters are a set of parameters generated by the display apparatus 200 based on hardware configuration, image quality processing algorithm, and user-set image quality mode.

To facilitate storage and retrieval, in some embodiments, the image quality processing parameters can also be formed into a data matrix according to a set data structure, namely a color matrix. The display apparatus 200 can obtain image quality parameters such as brightness, contrast, saturation, color temperature and hue through the middleware interface according to different chip solution providers and different image modes. Based on actual comparison experiments, it multiplies the parameters by a certain coefficient to obtain preprocessing parameters of the OSD layer display image similar to the video layer display image, and then stores these preprocessing parameters according to the Color Matrix data format.

For example, when the user sets the image quality mode of the display apparatus 200 to vivid mode, the display apparatus 200 can store image quality parameters such as brightness, contrast, saturation, color temperature and hue through the Color Matrix. These image quality parameters can obtain preset conversion coefficients based on actual comparison experiments to obtain preprocessed parameters such as brightness 0, contrast 15, saturation 50, color temperature −5 and hue 0. When the OSD layer displays image content with the above preprocessed parameters, it can obtain a display effect that is the same as or similar to the image content displayed by the Video layer under “vivid mode”.

For example, a Color Matrix can be stored in the following parameter format and converted into corresponding preprocessing parameters, i.e., ColorMatrix=new ColorMatrix( ). Specifically, for the brightness parameter, luminanceSet 0: ColorMatrix lumMatrix=new ColorMatrix( ); set the upper limit value int max=60; float property float lum=(float)(luminanceSet+max)*1f/max; lumMatrix.setScale(lum,lum,lum,1); //(1,1,1,1); colorMatrix.postConcet(lumMatrix).

For contrast parameters, contrastSet 15: ColorMatrix contrastMatrix=newColorMatrix( ); int max=60; float contrast=(float) (contrastSet+max)*1f/max; //1.25; contrastMatrix.setScale(contrast, contrast, contrast, 1); //(1.25,1.25,1.25,1); float [ ]array=contrastMatrix.getArray( ); array [4]=128*(1−contrast); //−32; array[9]=128*(1−contrast); //−32; array[14]=128*(1−contrast); //−32; colorMatrix.postConcet(contrastMatrix).

For the saturation parameter, saturationSet 50: ColorMatrix satMatrix=new ColorMatrix( ); int max=60; float sat=(float) (saturationSet+max)*1f/max; //1.8333334; satMatrix.setSaturation(set); //1.8333334; colorMatrix.postConcet (satMatrix).

For color temperature, colorTemperatureSet-5: ColorMatrix colorTemMatrix=new ColorMatrix( ); int max=60; float offset=(float) colorTemperatureSet*1f*100/max; //−10.0; if(colorTemperatureSet>0){float[ ]warmMatrix={1,0,0,0,offset*1.2f; 0,1,0,0,offset; 0,0,1,0,0; 0,0,0,1,0}; colorTemMatrix.set(warmMatrix); }else{float[ ]coldMatrix{1,0,0,0, Math.abs(offset)*0.1f; 0,1,0,0,Math.abs(offset); 0,0,1,0,Math.abs(offset)*1.2f; 0,0,0,1,0}; colorTemMatrix.set(coldMatrix)}; colorMatrix.postConcet(colorTemMatrix).

For hue, hueSet 0: ColorMatrix hueMatrix=new ColorMatrix( ); int max=600; //hue (−15 to 15); float hue=(float) hueSet*1f/max*180; //0.0; hueMatrix.setRotate(0,hue); hueMatrix.setRotate(1, hue); hueMatrix.setRotate(2, hue); colorMatrix.postConcet(hueMatrix).

After the above parameter transformation, the transformation result of the preprocessed parameters is as follows: colorMatrix={2.0697918, −0.7447917, −0.074999996, 0.0, −30.9999998; −0.22187501, 1.546875, −0.074999996, 0.0, −21.999998; −0.22187501, −0.7447917, 2.2166667, 0.0, −20.0; 0.0, 0.0, 0.0, 1.0, 0.0}.

It is evident that the image quality processing parameters are affected by fixed parameters such as hardware configuration and image quality processing algorithms, as well as variable parameters such as user settings. That is, when the user changes the image quality mode of the display apparatus 200, the corresponding image quality processing parameters will change. Therefore, in some embodiments, the display apparatus 200 can listen to the user's input setting commands in real time. When the user inputs a setting command to modify the image quality parameters, the display apparatus 200 can respond to the setting command, display the image quality setting interface, and call the image quality processing parameters. When a user inputs interactive actions based on the image quality settings interface to generate new image quality parameters, the display apparatus 200 can use the new image quality parameters to update the image quality processing parameters and can save the updated image quality processing parameters.

For example, when a user adjusts the image quality mode of the display apparatus 200 from “Vivid Mode” to “Soft Mode”, the display apparatus 200 can obtain image quality parameters such as brightness, contrast, saturation, color temperature and hue again through the middleware interface according to the new image quality mode, namely “Soft Mode”. Based on the preset conversion coefficient, it can obtain the preprocessing parameters of the OSD layer display image similar to the display image of the Video layer, and store these Color Matrix to achieve the purpose of updating the image quality processing parameters.

Since the display apparatus 200 can perform image quality processing on the image to be displayed using image quality processing parameters to generate a preview image displayed on the second layer. In some embodiments, the display apparatus 200 can detect the display content in the preview interface before obtaining the image quality processing parameters of the first layer. That is, the display apparatus 200 can traverse the images to be displayed in the preview interface. When the preview interface includes one or more images to be displayed, the display apparatus 200 can then execute the step of obtaining the image quality processing parameters of the first layer; when the preview interface does not include any images to be displayed, the step of obtaining the image quality processing parameters of the first layer cannot be executed, and the display 260 can be directly controlled to display the preview interface.

The display apparatus 200 can detect the image to be displayed in the preview interface by reading the configuration file of the preview interface. In some embodiments, the display apparatus 200 can, in response to a display command from the preview interface, obtain a configuration file of the preview interface and read key fields from the configuration file that characterize the image to be displayed. When the display apparatus 200 can read the key fields from the configuration file and the address parameters corresponding to the key fields are not empty, then it is determined that the preview interface includes the image to be displayed; otherwise, if the display apparatus 200 does not read the key fields from the configuration file, or the address parameters corresponding to the key fields are empty, then it is determined that the preview interface does not include the image to be displayed.

For example, after obtaining the display command for displaying the preview interface, the display apparatus 200 can obtain the configuration file of the preview interface and read the “ThumbnailView” field representing the thumbnail item in the configuration file. When the thumbnail item field “ThumbnailView=xx/DCIM/.thumbnails/photo11.jpg” is read, it is determined that the preview interface includes the image to be displayed. At this time, the display apparatus 200 can obtain the image quality processing parameters of the first layer.

When the display apparatus 200 displays the preview interface, since the preview interface includes display content related to media source data, such as thumbnails, and the preview interface is displayed through the second layer, the display apparatus 200 can obtain the image quality processing parameters of the first layer in order to render the image content in the preview interface according to the image quality processing parameters.

S200: perform image quality processing on the image to be displayed in the second interface according to the image quality processing parameters to generate a preview image, and control the display to display the preview image in the second layer.

After obtaining the image quality processing parameters of the first layer, the display apparatus 200 can read the image quality processing parameters and perform image quality processing on the image to be displayed according to the image quality processing parameters to generate a preview image. The preview image can be a processed image to be displayed. Therefore, after the preview image is generated, the display apparatus 200 can control the display 260 to display the preview image through the second layer to form a preview interface.

For example, when the display apparatus 200 enters the preview interface, the display apparatus 200 can load a preset ColorMatrix according to the current chip solution provider and “image quality mode”, that is, pre-processing parameters of brightness 0, contrast 15, saturation 50, color temperature −5, and hue 0. This ColorMatrix can be used to process the image of Thumbnail View in the OSD layer used to display thumbnails, and the processed image thumbnail can be displayed in the preview interface.

Similarly, when the preview interface is displayed on the display apparatus 200, the user changes the “image quality mode”, the ThumbnailView can be refreshed after processing according to the ColorMatrix corresponding to the newly changed image quality mode.

As can be seen, in the above embodiments, when the display apparatus 200 displays a preview interface containing an image to be displayed, the preview image in the second layer is processed according to the image quality processing parameters of the first layer, so that the display effect of the preview image in the preview interface displayed based on the second layer is similar to the display effect of the first layer. Therefore, when the media source data corresponding to the preview image is displayed in full-screen later, the display difference between the media source data displayed in full-screen and the preview image can be reduced, thereby improving the user experience.

In some embodiments, after the display apparatus 200 displays a preview image through the second layer, it can receive a play command input by the user for the preview interface, and after receiving the play command input by the user, control the display 260 to display the media source data corresponding to the preview image through the first layer.

Similarly, users can click on media source icons using control device 100 (remote control), touch interaction, voice interaction, or external devices such as a mouse to control display apparatus 200 to display media source content. At this time, display apparatus 200 can receive the play command input by the user and respond to the play command input to display media source content through the first layer.

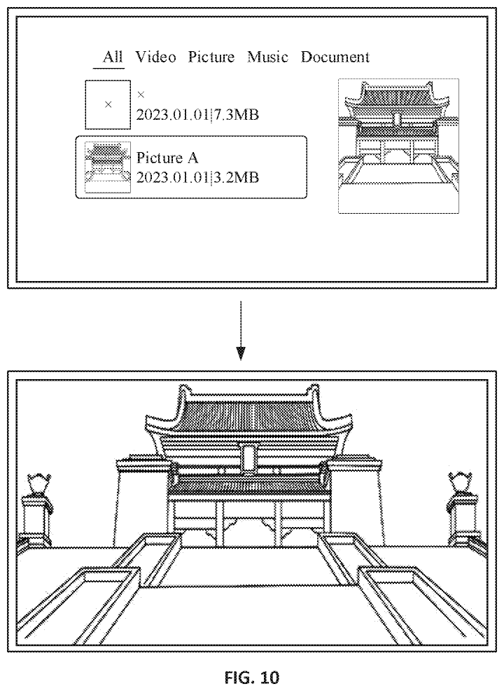

For example, as shown in FIG. 10, when a user controls the focus cursor to select the thumbnail of “Image A” in the file manager interface using a remote control and presses the “OK” button, the display apparatus 200 can decode and render the selected Image A and display it in full-screen through the video layer. At this time, since the thumbnail of image A is an image processed by the preview image rendering method in the above embodiment, its display quality in the OSD layer is the same as or similar to the display quality of image A in the video layer. Therefore, the difference in effect between the thumbnail of image A and the full-screen display of image A can be reduced, and the user experience can be improved.

When switching interfaces, the display apparatus 200 can display transition animations, some of the transition animations can be generated in real time based on media source data. For example, when a user clicks on “Image A” in the preview interface, the display apparatus 200 can generate a transition animation based on the content of Image A before displaying Image A in full-screen. That is, the animation effects of Image A gradually enlarging from the thumbnail position to the full-screen display.

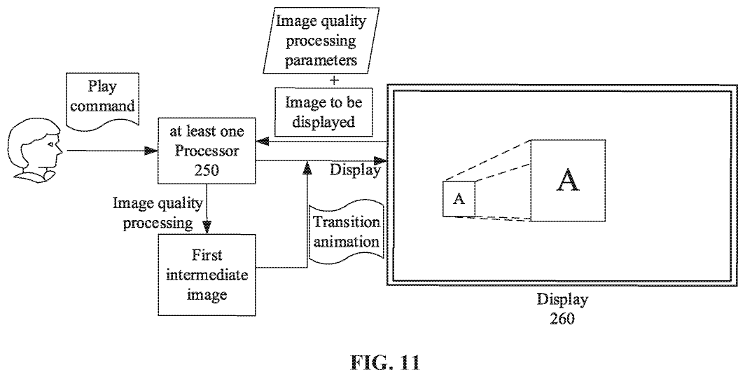

Since the preview interface and transition animations are displayed on the second layer, while the play image after switching is displayed on the first layer, there can be differences in display effects between the transition animations and the play image when switching interfaces. Based on this, as shown in FIG. 11, in some embodiments, the display apparatus 200 can also obtain the play command input by the user based on the second interface, and obtain the image quality processing parameters of the first layer in response to the play command. Then, the image to be displayed in the preview interface is processed according to the image quality processing parameters to render the first intermediate image. Then, a transition animation is generated based on the first intermediate image, and the display 260 is controlled to display the transition animation through the second layer, so that the display effect of the transition animation is the same as the display effect of the first interface.

The display apparatus 200 can obtain the image quality processing parameters of the first layer in the same way as the method of obtaining the image quality processing parameters in the above embodiments. In addition, the display apparatus 200 can perform image quality processing on the image to be displayed in the preview interface according to the image quality processing parameters to render the first intermediate image, which can also be the same as the method of rendering the preview image according to the image quality processing parameters in the above embodiments. The difference is that the first intermediate image generated in this embodiment is used to generate the transition animation, while the preview image generated in the above embodiment is used to be displayed in the preview interface.

For example, when the user sets the image quality mode of the display apparatus 200 to “Vivid Mode”, then after the user clicks the “Image A” option in the preview interface, the display apparatus 200 can obtain the play command for Image A. At this time, the display apparatus 200 can load a preset ColorMatrix according to the current chip solution provider and the “image quality mode”, and use this ColorMatrix to process the image of the Transitions View used by the OSD layer to generate the transition animation, that is, generate the first intermediate image, and then generate the transition animation by scaling in on the first intermediate image frame by frame, thereby displaying the transition animation through the OSD layer.

As can be seen, in the above embodiments, the display apparatus 200 can render a first intermediate image through the image quality processing parameters of the first layer during the interface switching process, and generate a transition animation based on the first intermediate image, so that the image display effect displayed in the transition animation is the same as or similar to the image display effect displayed in the play image, thereby reducing the display effect difference between the transition animation and the play image and improving the user experience.

Since transition animations need to be displayed not only during the switching of interfaces when playing media sources, but also during the switching of interfaces when exiting media source play. Therefore, in some embodiments, the user can control the display apparatus 200 to present a second interface. That is, the display apparatus 200 can respond to the preview command input by the user for displaying the second interface and obtain the media source data displayed in the second interface. Then read the first key frame of the media source data to obtain the cover image. Based on the image view parameters of the second interface, the cover image is cropped and/or scaled to generate icons for the media source data. Then control the display to show the icons of the media source data through the second interface.

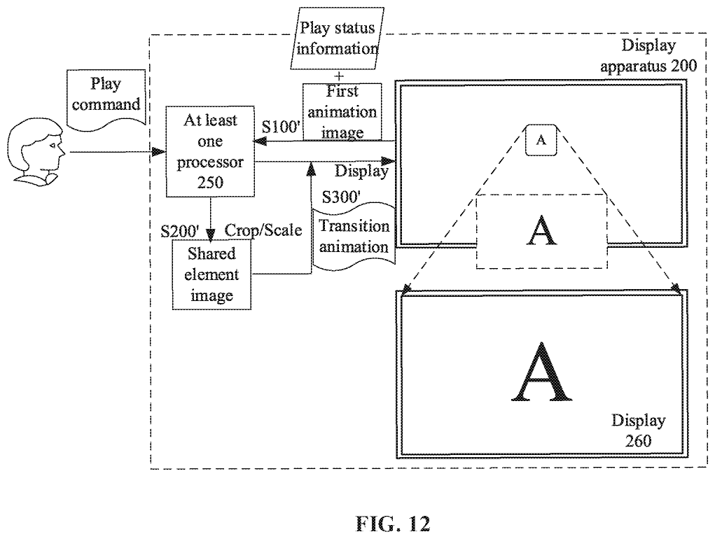

Since the first interface and the second interface have different interface types and different interface elements, when a transition animation is generated based on the interface elements in the first interface and the second interface as shared elements, the transition animation differs greatly from the content displayed in the user interface after the switch. In order to reduce the difference between the transition animation and the content displayed on the interface after the switch when the display apparatus 200 switches the user interface, some embodiments of the present application provide another animation display method for the display apparatus, where the display 260 can still be used to display the first interface or the second interface. The first interface can be used to display the play image of the media source data; the second interface can be used to display the icon screen of the media source data (such as the aforementioned preview image). As shown in FIG. 12, at least one processor 250 can also be configured to execute computer instructions stored in memory to cause the display apparatus 200 to perform the program steps corresponding to the aforementioned method, which can include some or all of the following operations.

S100′: when the second interface is displayed on the display 260, obtain the play status information in response to the play command input by the user for playing media source data.

When the display apparatus 200 displays the second interface, the second interface can include an icon image of media source data. Users can interact with the icons of media sources through device control, touch interaction, voice interaction, and other interactive actions to input play commands. On the one hand, the play command controls the display apparatus 200 to perform play operations on the media source data, such as decoding and rendering. On the other hand, it can control the display apparatus 200 to switch from the second interface to the first interface.

During the process of switching from the second interface to the first interface, the display apparatus 200 can call the shared element animation generation service to create transition animations. To improve the transition effect between the transition animation and the play image, the display apparatus 200 can obtain play status information after receiving the play command input by the user. The play status information can be used to adjust the shape of shared elements in shared element animations. Therefore, the play status information can include the image display parameters when the first interface displays the play image of the media source data.

Among them, the display parameters can be generated based on the play mode of the media source data played by the display apparatus 200. The play modes of the display apparatus 200 can include full-screen scaling mode, original aspect ratio mode, original size mode, etc. the full-screen scaling mode is a mode that displays the play image in full-screen according to the screen width and the screen height of the display 260. The original aspect ratio mode is the mode in which the play image is displayed according to the aspect ratio of the media source data and the screen width or height of the display 260. The original size mode displays the play image according to the image width and the image height of the media source data.

Since the reference for displaying the play image on the display apparatus 200 is different under different play modes, the shape and display position of the play image presented by the display apparatus 200 under different play modes are different. Therefore, in some embodiments, the display apparatus 200 can generate different image display parameters according to different play modes. That is, when at least one processor 250 executes the acquisition of play status information, it is further configured to execute the aforementioned computer instructions to make the display apparatus 200 perform: detect the play mode of the media source data of the display apparatus 200. The play mode can be obtained by reading the setting parameter list of the display apparatus 200. That is, the display apparatus 200 can create and maintain the setting parameter list according to the user's settings. The setting parameter list can record the user's setting parameters for the display apparatus 200.

For example, when the display apparatus 200 reads “play mode-01” in the setting parameter list, it means that the current play mode is “full-screen scaling mode”; when the display apparatus 200 reads “play mode=10” in the setting parameter list, it means that the current play mode is “original aspect ratio mode”; when the display apparatus 200 reads “play mode=11” in the setting parameter list, it means that the current play mode is “original size mode”.

The image display parameters can be generated by detecting the play mode of media source data on the display apparatus 200, when the play mode is a full-screen scaling mode, the screen size information of the display can be obtained, and the image display parameters can be generated based on the screen size information. For example, when the play mode is detected to be full-screen scaling mode, the screen size information of the display 260 can be obtained, namely the screen width 3840 and the screen height 2160, in order to generate image display parameters including screen size information.

When the play mode is the original aspect ratio mode, the image size information and scaling reference of the media source data can be obtained, and the image display parameters can be generated based on the image size information and scaling reference. The scaling reference is the screen width or screen height of the display. The scaling reference can be determined based on the relationship between the image size of the media source data and the screen size of the display 260.

In order to determine the scaling reference and generate display parameters, in some embodiments, the display apparatus 200 can acquire the image size information of the media source data and the screen size information of the display. The image size information can include the image width VW and the image height VH; the screen size information can include the screen width W and the screen height H.

After obtaining the screen size information, the display apparatus 200 can calculate the image aspect ratio, which is the ratio of the image width to the image height, VW/VH, and calculate the screen aspect ratio, which is the ratio of the screen width to the screen height, W/H. Then, the image aspect ratio is compared with the screen aspect ratio, and the display region of the effective image in the play image is determined based on the comparison result, namely (left, top, right, bottom).

When the image aspect ratio is equal to the screen aspect ratio, i.e., VW/VH=W/H, then the scaling reference can be determined as the screen width W or the screen height H, i.e. the effective image is displayed in full-screen. Therefore, the image display parameters can be generated based on the screen width W and the screen height H, and the coordinate range of the effective image display region is (0, 0, W, H).

When the image aspect ratio is less than the screen aspect ratio, i.e., VW/VH<W/H, then the scaling reference can be determined as the screen width W, and the image display parameters can be generated based on the screen width and the image size information. That is, the screen width W can be used as the image width, and the image height of the shared element image can be calculated based on the screen width W and the image aspect ratio VW/VH. When

$$\frac{W}{H} < \frac{VW}{VH} ,$$

the play image is displayed in landscape mode, the play image height is

$$\frac{W}{VW} \times VH ,$$

the play image width is W; the coordinate range of the effective image display region is

$$( 0 , \frac{H}{2} - \frac{VH}{2} \times \frac{W}{VW} , W , \frac{H}{2} + \frac{VH}{2} \times \frac{W}{VW} ) .$$

When the image aspect ratio is greater than the screen aspect ratio, the scaling reference can be determined as the screen height, and the image display parameters can be generated based on the screen height and the image size information. That is, the screen height can be used as the image height, and the image width of the shared element image can be calculated based on the screen height and the image aspect ratio, where the image height of the shared element image is the product of the screen width and the image aspect ratio.

When

$$\frac{W}{H} > \frac{VW}{VH} ,$$

the play image is in vertical display mode, the play image height is H, the play image width is

$$\frac{VW}{VH} \times H ;$$

the coordinate range of the effective image display region is

$$( \frac{W}{2} - \frac{H}{2} \times \frac{VW}{VH} , 0 , \frac{W}{2} + \frac{H}{2} \times \frac{VW}{VH} , H ) .$$

When the play mode is the original size mode, the image size information of the media source data can be obtained, namely the image width VW and the image height VH, and the image display parameters can be generated based on the image size information. For example, when the play mode is detected to be the original size mode, the image width 1920 and the image height 1080 of the media source data to be played can be obtained to generate image display parameters including image size information.

In some embodiments, in order to further improve the transition effect between the transition animation and the play image, the play status information can also be used to adjust the display effect of the shared elements in the shared element animation. Therefore, the play status information can also include image quality processing parameters when the first interface displays the play image of the media source data. Among them, the image quality processing parameters are a set of parameters generated by the display apparatus 200 based on information such as hardware configuration, image quality processing algorithm and image quality mode set by the user.

To facilitate storage and retrieval, in some embodiments, the image quality processing parameters can also be formed into a data matrix according to a set data structure, namely a color matrix. The display apparatus 200 can obtain image quality parameters such as brightness, contrast, saturation, color temperature and hue through the middleware interface according to different chip solution providers and different image modes. It can also multiply these parameters by a certain coefficient based on actual comparison experiments to obtain preprocessing parameters for the OSD layer display image, which is similar to the display image of the video layer. These preprocessing parameters are then stored in the data format of Color Matrix.

S200′: generate a shared element image based on the play status information and the first animation image.

The first animation image can be an image obtained based on the icons in the media source data. After obtaining the play status information, the display apparatus 200 can process the shared elements (i.e., the first animation image) in the transition animation according to the play status information, crop and/or scale the shared element image, thereby generating a shared element image. During media source play, the display apparatus 200 can use the media source data icon, or the cover image associated with the media source data icon, as a shared element. After processing based on play status information, the aspect ratio of the shared element image can be equal to the aspect ratio of the media source data play image.

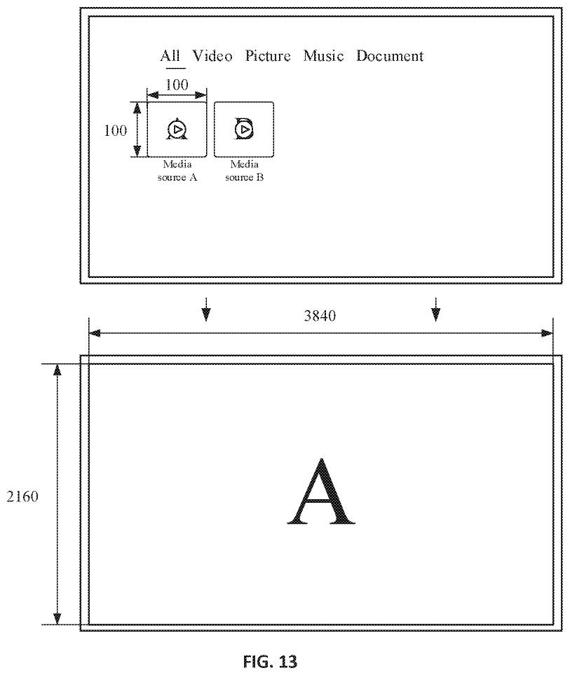

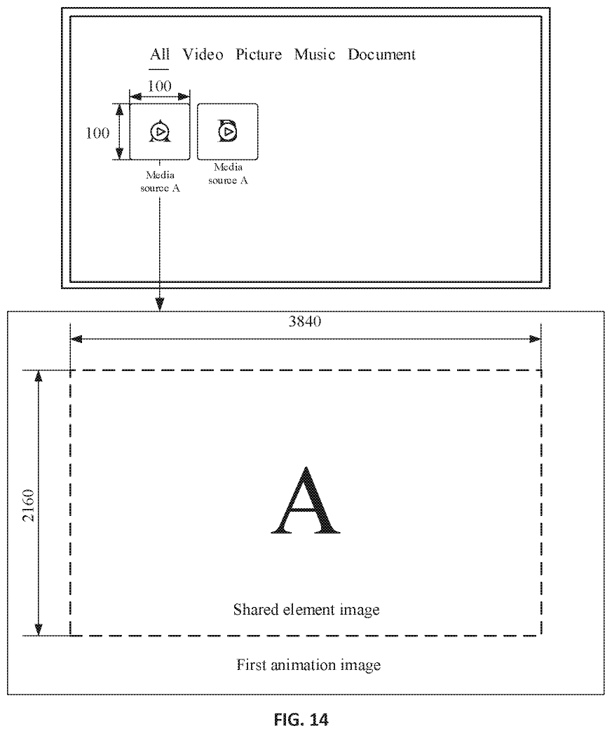

For example, in the preview interface, when the icon of the media source data is a thumbnail of the first frame of the media source, then the display apparatus 200 can use this thumbnail as a shared element when switching from the preview interface to the play interface. As shown in FIG. 13, when the thumbnail is displayed in the preview interface, it is a rounded square shape, that is, the aspect ratio of the thumbnail is 100:100. The aspect ratio of the play image is determined based on the play status information. In full-screen scaling mode, the aspect ratio of the play image is 3840:2160. At this point, since the aspect ratio of the thumbnail is different from that of the play image and it has rounded corners, as shown in FIG. 14, the shared element image needs to be scaled and cropped according to the aspect ratio of the play image to generate a shared element image with an aspect ratio of 3840:2160.

In some embodiments, in order to obtain a shared element image, at least one processor 250 performs the action of generating a shared element image based on the play status information and the first animation image, and is further configured to execute the aforementioned computer instructions to cause the display apparatus 200 to perform: obtaining the first animation image, the first animation image can be an icon of the media source data or a cover image associated with the media source data. When the display apparatus 200 displays the preview interface, it can perform preliminary reading of the media source data in the preview interface and obtain the cover image of the media source data. The cover image can be the first frame of the media source data, or it can be the cover image set by the maintenance provider for the media source data. Display apparatus 200 can crop and/or scale the image based on the cover image to generate a thumbnail for display in a media source data list. Since thumbnails are small in size and do not need to display details of the image content, in some embodiments, thumbnails can be compressed during cropping and/or scaling to reduce the amount of data in the thumbnail.

Thumbnails can be stored in the memory of display apparatus 200, for example, in the “.thumbnails” folder of display apparatus 200. Therefore, when generating a shared element image, the display apparatus 200 can obtain the icon image of the media source data by reading the “.thumbnails” folder, and use it as the first animation image.

Since the thumbnail is small in size, the details of the image content can be lost due to compression or scaling. In some use cases, if the thumbnail is used directly to generate the shared element image, the image quality of the thumbnail will affect the animation display effect. Therefore, in some embodiments, the display apparatus 200 can save the original cover image while storing the thumbnail, and when generating the shared element image, it can read the cover image associated with the media source data from the storage folder, that is, the original cover image.

After acquiring the first animation image, the display apparatus 200 parses the image display parameters from the play status information, where the image display parameters can include the image width and the image height. Then, the first animation image is cropped and/or scaled according to the image display parameters to obtain the shared element image.

In some embodiments, when the play status information further includes the image quality processing parameters of the first layer, the display apparatus 200 can also parse the image quality processing parameters of the first layer from the play status information after acquiring the first animation image. The image (such as the first animation image or the first animation image cropped and/or scaled according to the image display parameters) is then processed according to the image quality processing parameters to render the shared element image. Then, S300′ is executed to generate a transition animation based on the shared element image, and the display 260 is controlled to display the transition animation through the second layer, so that the display effect of the transition animation is the same as the display effect of the first interface.

The display apparatus 200 can obtain the image quality processing parameters of the first layer in the same way as the method of obtaining the image quality processing parameters in the above embodiment. In addition, the display apparatus 200 can perform image quality processing on the image to be displayed in the preview interface according to the image quality processing parameters to render the first intermediate image, which can also be the same as the method of rendering the preview image according to the image quality processing parameters in the above embodiments. The difference is that the first intermediate image generated in this embodiment is used to generate the transition animation, while the preview image generated in the above embodiments is used to be displayed in the preview interface.

For example, when the user sets the image quality mode of the display apparatus 200 to “Vivid Mode”, then after the user clicks the “Image A” option in the preview interface, the display apparatus 200 can obtain the play command for Image A. At this time, the display apparatus 200 can load a preset ColorMatrix according to the current chip solution provider and the “image quality mode”, and use this ColorMatrix to process the image of the Transitions View used by the OSD layer to generate the transition animation, that is, generate the first intermediate image, and then generate the transition animation by scaling in on the first intermediate image frame by frame, thereby displaying the transition animation through the OSD layer.

As can be seen, in the above embodiments, the display apparatus 200 can render a first intermediate image through the image quality processing parameters of the first layer during the interface switching process, and generate a transition animation based on the first intermediate image, so that the image display effect displayed in the transition animation is the same as or similar to the image display effect displayed in the play image, thereby reducing the display effect difference between the transition animation and the play image and improving the user experience.

S300′: generate a transition animation based on the shared element image, and control the display to sequentially display the transition animation and the first interface.

After generating the shared element image, the display apparatus 200 can generate a transition animation based on the shared element image. For example, after generating the shared element image, the display apparatus 200 can call the transition animation generation service and set the shared element image as the ShareElementView of the transition animation generation service.

In some embodiments, when the preview interface and the play interface are displayed on different layers, that is, the first interface is displayed on the first layer and the second interface is displayed on the second layer. The display apparatus 200 can generate multiple transition frames based on the icon display position and play image display region of the media source data, where each transition frame can include at least one image view. The shared element image is then set in the image view of multiple transition frames, and the play time is set for the multiple transition frames to generate a transition animation.

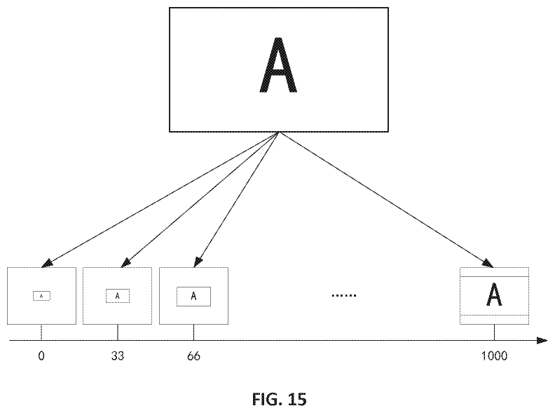

For example, as shown in FIG. 15, the video play on the Android-based display apparatus 200 is at the Video layer, and animation cannot be performed directly. Therefore, a specific ImageView is used to display the video thumbnail as a shared element for animation transition in the OSD layer. The display apparatus 200 can adjust the bitmap in the Image View according to different play modes, and obtain a shared element image (3840×2160) with the same size as the play image.

Then, based on the size of the thumbnail (100×100) and the size of the display image in the play interface (3840×2160), determine the original scale (100/2160≈5%) and the final scale of 100%. Then, based on the original and final scales, and the transition animation frame count of 30, and 30 transition frames can be created. In the 30 transition frames, the shared element image in the first transition frame is scaled to 5%, the shared element image in the second transition frame is scaled to 8%, the shared element image in the third transition frame is scaled to 11%, and so on, until the shared element image in the last transition frame is 100%. Then, according to the play duration of the transition animation, the play time can be set for each of the 30 transition frames to generate a transition animation containing multiple consecutive transition frames.

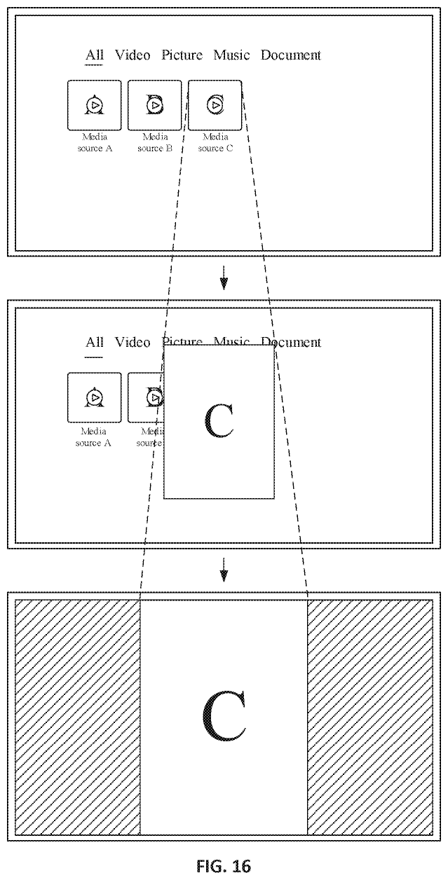

After the transition animation is generated, the display apparatus 200 can display the generated transition animation. That is, the display apparatus 200 switches from the display preview interface to the display transition animation, and then switches to the play interface. In some embodiments, when the preview interface and the play interface are displayed in different layers, the display apparatus 200 can display the transition animation through the layer used by the preview interface since the play interface cannot directly display the animation. For example, as shown in FIG. 16, when the display apparatus 200 displays the preview interface through the OSD layer, it can first display a transition animation through the OSD layer. After the transition animation ends, the OSD layer is hidden to switch to displaying the play interface through the video layer.

As can be seen from the above scheme, the animation display method for display apparatuses in the above embodiments can obtain play status information including image display parameters when the first interface displays the play image of the media source data after the user inputs the play command of the media source data, and then generate a shared element image based on the play status information and the first animation image, and can generate a transition animation based on the shared element image. Since the aspect ratio of the shared element image can be equal to that of the media source data play image, the difference between the thumbnail, transition animation and the displayed content of the play image can be reduced, and the coordination and smoothness of the transition animation can be improved.

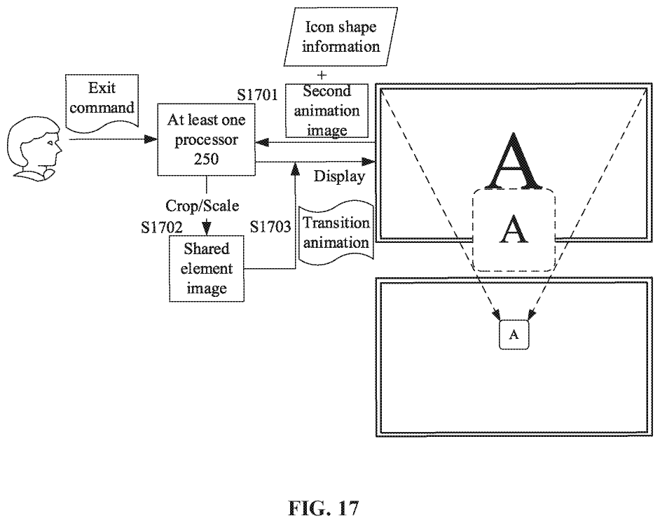

Corresponding to the above media play process, the display apparatus 200 further needs to display a transition animation during the exit play process. That is, in some embodiments of the present application, an animation display method suitable for the exit play process is also provided. The same method is also applied to display apparatus 200, which can include display 260, memory and at least one processor 250. The display 260 can be configured to display a first interface or a second interface. The first interface can be used to display the play image of the media source data; the second interface can be used to display the icon screen of the media source data. As shown in FIG. 17, at least one processor 250 can be configured to execute computer instructions stored in the memory to cause the display apparatus 200 to perform some or all of the following operations.

S1701: based on that the display displays the first interface, in response to the user's exit command to stop playing media source data, obtain the icon shape information of the media source data.

S1702: generate a shared element image based on the icon shape information and the second animation image, where the second animation image is an image obtained based on the content displayed on the first interface; the shape of the shared element image is the same as the icon shape of the media source data.

S1703: generate a transition animation based on the shared element image, and control the display to sequentially display the transition animation and the second interface.

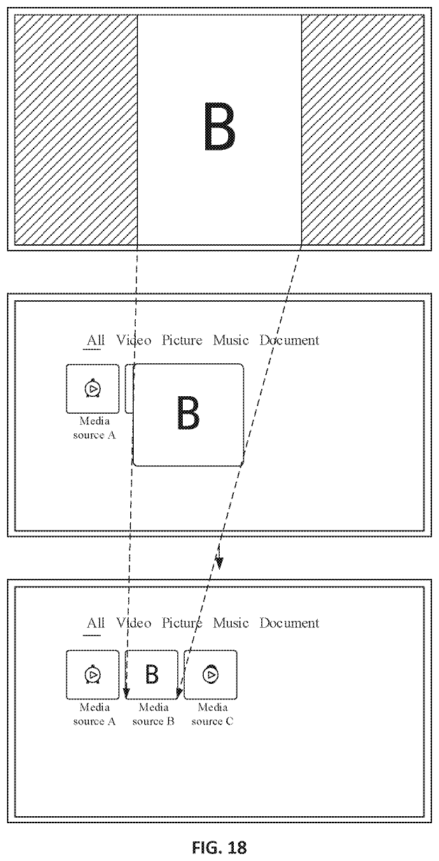

For example, as shown in FIG. 18, when the display apparatus 200 is playing media source data, the user can enter an exit command by pressing the “back” button on the remote control. The display apparatus 200 can then respond to the exit command by displaying information such as the aspect ratio and rounded corners of the Thumbnail View in the preview interface. The moment the display apparatus 200 detects that the user has clicked the “back” button to exit play, the current video frame can be obtained from the video buffer and used as a second animation image. Furthermore, based on the width, height, aspect ratio, and rounded corners of the Thumbnail View in the preview interface, video frames can be cut into bitmaps of the same shape for generating transition animations.

In some embodiments, the at least one processor 250 performs the function of generating a shared element image based on the icon shape information and the second animation image, and is further configured to execute the aforementioned computer instructions to cause the display apparatus 200 to perform: firstly, parse the icon size information and icon vertex shape from the icon shape information, and then extract the current frame image of the media source data from the frame buffer.

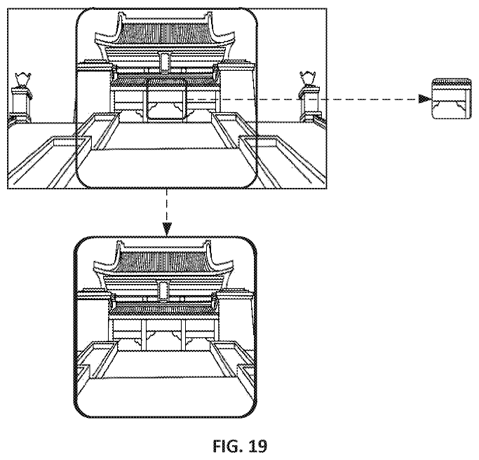

After acquiring the current frame image (the second animation image), the display apparatus 200 can crop the second animation image in two different ways. Firstly, according to the icon size information and the icon vertex shape, the central region of the current frame image is cropped to obtain the shared element image. The video frame can be cropped at the center position according to the width, height, and rounded corners of the Thumbnailview, as shown in FIG. 19.

For example, the ThumbnailView in the preview interface has a width of ViewW, a height of ViewH, and rounded corners with an arc of r. The video display width is VideoW, and the video display height is VideoH. The coordinates of the cropped bitmap rectangle are (left, top, right, bottom). Then the display apparatus 200 can crop a bitmap of ViewWx ViewH at the center point of the video, based on the width of Thumbnail View in the preview interface as ViewW and the height of Thumbnail View in the preview interface as ViewH. The coordinates of the bitmap rectangle are determined as follows: left=VideoW/2−ViewW/2; top=VideoH/2−ViewH/2; right=VideoW/2+ViewW/2; bottom=VideoH/2+ViewH/2, thus obtaining the shared element image.

Secondly, the display apparatus 200 can crop the current frame image according to the icon vertex shape and the proportional relationship between the size parameters of the current frame image and the icon size information to obtain the shared element image. The current frame image can be cropped proportionally based on the width and height of the view and the width and height of the video.

For example, display apparatus 200 can crop the maximum bitmap at the center point of the video proportionally. When

$$\frac{VideoW}{VideoH} = \frac{ViewW}{ViewH} ,$$

the copping rectangle with height of VideoH, the copping width of VideoW, coordinates of (0, 0, VideoW, VideoH). When

$$\frac{VideoW}{VideoH} > \frac{ViewW}{ViewH} ,$$

the copping rectangle with height of VidoeH, width of

$$\frac{ViewW}{ViewH} \times VideoH ,$$

coordinates of

$$( \frac{V i d e o W}{2} - \frac{V i d e o H}{2} \times \frac{V i e w W}{V i e w H} , 0 , \frac{V i d e o W}{2} + \frac{V i d e o H}{2} \times \frac{V i e w W}{V i e w H} ,$$

### VideoH). When

$$\frac{VideoW}{VideoH} < \frac{ViewW}{ViewH} ,$$

the copping rectangle with height of

$$\frac{V i d e o W}{V i e w W} \times ViewH ,$$

width of VideoW, coordinates of

$$( ( 0 , \frac{V i d e o H}{2} - \frac{V i e w H}{2} \times \frac{V i d e o W}{V i e w W} , VideoW , \frac{V i d e o H}{2} + \frac{V i e w H}{2} \times \frac{V i d e o W}{V i e w W} ) .$$

After obtaining the shared element image based on the above cropping method, the display apparatus 200 can put this bitmap back into the Image View, and can use this bitmap to update the thumbnailView corresponding to the currently playing media source in the thumbnail cache pool, and can use this Image View to perform the transition effect of the shared element animation to return to the preview interface.

As can be seen from the above solutions, the display apparatus provided in the above embodiments can obtain the icon shape information of the media source data in the second interface (preview interface) after the user inputs an exit command to stop playing the media source data, and then generate a shared element image based on the icon shape information and the second animation image, and can generate a transition animation based on the shared element image. Since the shape of the shared element image is the same as the icon shape of the media source data, the difference between the transition animation and the displayed content of the play image can be reduced, thereby improving the coordination and smoothness of the transition animation.

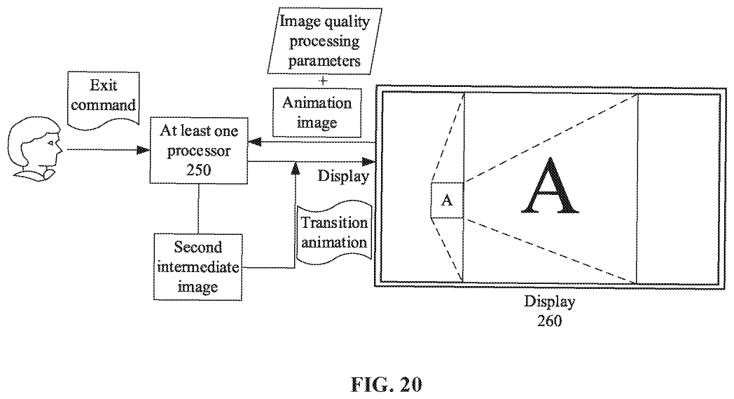

As shown in FIG. 20, in some embodiments, for the process of exiting the play interface, the display apparatus 200 can receive an exit command input by the user based on the first interface for exiting the play interface, and in response to the exit command, can obtain the image quality processing parameters of the first layer. Based on the content displayed in the first layer, the animation images can be generated. Then, the animation is processed according to the image quality parameters of the first layer to generate the second intermediate image. The display apparatus 200 can generate a transition animation based on the second intermediate image and control the display 260 to display the generated transition animation, so that the display effect of the transition animation is consistent with the display effect of the first interface.

The difference between this embodiment and the above embodiments is that after obtaining the image quality processing parameters of the first layer, the display apparatus 200 needs to generate an animation image based on the display content of the first layer. A second intermediate image is generated based on the animation image and image quality processing parameters.

For example, after obtaining an exit command from the user, the display apparatus 200 can load a preset ColorMatrix according to the current chip solution provider and “image quality mode”, and can perform a screenshot operation on the image displayed in the video layer to generate an image of the Transitions View in the OSD layer for generating transition animations. Then, the loaded ColorMatrix is used to process the image of the Transitions View, which generates a second intermediate image. Based on the logic for generating the exit animation, the display apparatus 200 can scale down the second intermediate image frame by frame to generate a transition animation that includes continuously scaled-down graphics, which is then displayed in the OSD layer.

The animation images can be generated directly from the source file of the media source data played in the first layer, or they can be generated by taking a screenshot of the currently displayed image of the first layer. In some embodiments, when the display apparatus 200 generates an animation image based on the display content of the first layer, it can detect the media source type of the media source data to be played corresponding to the first layer. When the media source type is a first type of media source, a screenshot is taken of the content displayed in the first layer to generate an animation image; when the media source type is a second type of media source, an animation image is generated based on the media source.

The first type of media source can be used to characterize media source types that cannot be directly used to generate animations. For example, the first type of media source can be video media sources, animation media sources, and other media sources that contain dynamically displayed content. The first type of media source can also be text media sources, graphic media sources, special format files, and other media sources that do not contain dynamically displayed content but cannot be directly used to generate animations. The second type of media source can be used to characterize the type of media source that can directly generate animation. For example, the second type of media source can be image media sources, which do not contain dynamic display content and can be directly used to generate animations.

It should be noted that, since the transition animation generation logic of different display apparatuses 200 is different, in some embodiments of the application, the animation image can be one or more, to be adapted to different animation generation logics respectively. For example, when the transition animation of the display apparatus 200 requires the generation of 5 key frames, the display apparatus 200 needs to generate 5 animation images based on the display content of the first layer.

As can be seen, in the above embodiments, when the display apparatus 200 exits play, it can also generate a second intermediate image based on the image quality processing parameters of the first layer, generate an exit transition animation based on the second intermediate image, and then display the transition animation through the second layer. Since the second intermediate image has also been processed according to the image quality parameters, the difference in display effect between the transition animation and the play image can be reduced, as well as the difference in display effect between the transition animation and the thumbnail in the preview interface, thus improving the user's viewing experience of the exit animation.

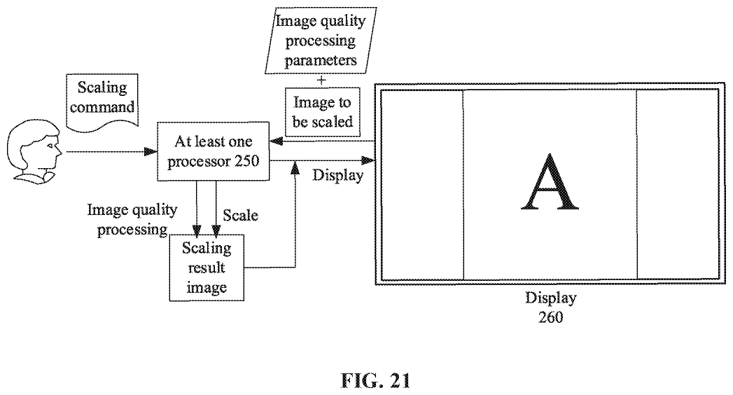

Based on the above embodiments, the play image of the display apparatus 200 is displayed on the first layer. When the user performs a zoom in operation, due to the good dynamic response effect of the second layer, display apparatus 200 can display the zoomed in local image through the second layer. When users perform scaling operations, the display effect can vary greatly depending on the layer being displayed. As shown in FIG. 21, in some embodiments, the display apparatus 200 can receive a scaling command input by the user based on the first interface for scaling the play image in the first interface when displaying the play interface. After receiving a scaling command, the display apparatus 200 can respond to the scaling command to obtain the image quality processing parameters of the first layer and obtain the image to be scaled. Next, image quality processing is performed on the image to be scaled according to the image quality processing parameters, and the image to be scaled after image quality processing is scaled to generate a scaled result image, and then the display is controlled to display the scaled result image.

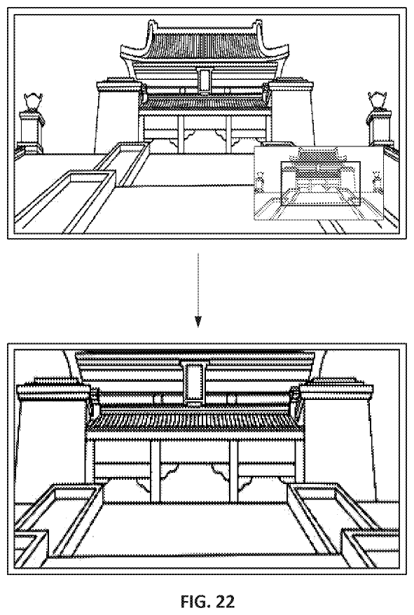

For example, as shown in FIG. 22, when the display apparatus 200 displays image A in full-screen through the video layer, the user can use the “up” arrow key on the remote control to input a scaling command to enlarge image A. After receiving the scaling command input by the user, the display apparatus 200 first loads the preset ColorMatrix according to the current chip solution provider and the “image quality mode”, and then obtains the ZoomImage View image for scaling. Display apparatus 200 performs image quality processing on the ZoomImage View image using the current ColorMatrix, and then performs a scaling operation to obtain a scaled result image including a portion of the enlarged image A, which is then displayed through the OSD layer.

In the zoomed in state, when the user switches to the “image quality mode”, the display apparatus 200 can update the image quality processing parameters and perform image quality processing on the scaled result image according to the ColorMatrix corresponding to the newly changed mode, as well as refresh ZoomImage View using the scaled result image after image quality processing.

Similarly, when a user controls the image to be reduced in size, the image can be processed using image quality parameters before display. For example, when the display apparatus 200 displays an enlarged image A through the OSD layer, the user can input a scaling command to reduce the size of image A using the “down” arrow key on the remote control. Display apparatus 200 can respond to scaling commands to control the display content of the hidden OSD layer, so as to restore the display state of the full-screen image A in the video layer.

It should be noted that the scaling operation of an image can be performed in different ways depending on the user's specific interaction. For example, the scaling level varies depending on the number of times or the duration a user presses the arrow keys. Therefore, in some embodiments, during the scaling process of the image to be scaled after image quality processing, the display apparatus 200 can parse the scaling ratio from the scaling command and scale the image to be scaled according to the scaling ratio.

In order to resolve the scaling ratio, the display apparatus 200 can obtain the interaction action parameters corresponding to the scaling command and extract the interaction action value from the interaction action parameters. Among them, the interaction action value can be represented by different parameter types depending on the interaction method. For example, when a user inputs a scaling command by repeatedly pressing the arrow keys on the remote control, the interaction action value can be the number of presses; when a user inputs a scaling command by long-pressing the arrow keys on the remote control, the interaction action value can be the duration of the long press; for a display apparatus 200 that supports touch interaction, when a user inputs a scaling command by sliding two fingers inward or multiple fingers outward, the interaction action value can be the sliding distance of the two fingers.

After extracting the interaction action values, the display apparatus 200 can determine the scaling ratio according to the mapping relationship between the interaction action values and the scaling ratio. For example, when the display apparatus 200 sets the scaling ratio of each press of the arrow keys on the remote control to 20%, then after the user inputs a scaling command, the display apparatus 200 can obtain the interaction action parameters of the corresponding press of the arrow keys, extract the number of presses from the interaction action parameters, and determine the scaling ratio to be 40% when the number of presses is 2. Then, the image to be scaled after image quality processing is scaled by 40% to obtain the scaled result image after 40% scaling.

Since the display apparatus 200 adds a transition animation when performing a scaling operation on the image, and the transition animation of the scaling operation is also displayed through the second layer. Therefore, in some embodiments, the display apparatus 200 can generate and display the transition animation of the scaling process in accordance with the transition animation display method in the above embodiments.

For example, when the display apparatus 200 is displaying image A in full-screen through the video layer, and the user inputs a scaling command for magnification, the display apparatus 200 can generate a scaled result image according to the scaling display method provided in the above embodiments after receiving the scaling command. Furthermore, the display apparatus 200 can generate an animation image based on the transition animation generation and display method provided in the above embodiments. First, generate an animation image based on the full screen display of image A. Then, use ColorMatrix to perform image quality processing on the animation image to generate an intermediate image. Then, generate a transition animation based on the intermediate image and the scaled result image to create an animated effect of transitioning from the intermediate image to the scaled result image, which is displayed in the OSD layer.

As can be seen from the above solutions, the display apparatus provided in the above embodiments can respond to the display command, play command, exit command and scaling command input by the user, obtain the image quality processing parameters of the first layer, and perform image quality processing on the image content to be displayed based on the image quality processing parameters, and then display it through the second layer. Among them, the image quality processing parameters can be a set of parameters generated based on the configuration information of the display apparatus and the current image quality mode. By using image quality processing parameters to perform image quality processing on the content to be displayed, the difference in display effect between the second layer and the first layer can be reduced, the consistency of the image during the switching process between the first layer and the second layer can be enhanced, and the problem of large color difference between the displayed images (such as thumbnails and transition animations) and the play images can be solved.

It should be noted that the above embodiments only use the process of entering the preview interface, the media source play process, the process of exiting the media source play process, and the process of exiting the play interface as examples to describe the animation display method for the display apparatus. It should be understood that the above-described animation display method can be applied to the animation display process between any interface switching of the display apparatus 200. Therefore, other animation display methods for scenarios that are conceived by those skilled in the art based on the above-described animation display method are also within the protection scope of the present application.

The same or similar portions among the various embodiments in this specification can be referred to mutually, and will not be repeated here.

Finally, it should be noted that the above embodiments are only used to illustrate the solutions of the present application, and are not intended to limit them. Although the present application has been described in detail with reference to the foregoing embodiments, those skilled in the art should understand that modifications can still be made to the solutions described in the foregoing embodiments, or equivalent substitutions can be made to some or all of the technical features therein. Such modifications or substitutions do not cause the essence of the corresponding solutions to deviate from the scope of the solutions of the embodiments of the present application.

What is claimed is:

1. A display apparatus, comprising:
a display;
a memory, configured to store computer instructions and data associated with the display apparatus;
at least one processor, communicatively connected to the display and the memory; wherein the at least one processor is configured to execute the computer instructions to cause the display apparatus to perform:
providing a first layer and a second layer, wherein the first layer is a video layer configured to display a first interface presenting a media source play image processed via an image quality processing, and the second layer is an On Screen Display (OSD) layer configured to display a second interface presenting a media source icon image; different image quality processings are performed on displayed image content in the first layer and displayed image content in the second layer;
based on that the second interface is displayed in the second layer on the display, in response to a play command input by a user for playing media source data, obtaining play status information; wherein the play status information comprises an image quality processing parameter of the first layer;
generating a shared element image based on the play status information and a first animation image, wherein the first animation image is a thumbnail icon of the media source data or a cover image associated with the media source data; and an aspect ratio of the shared element image is equal to an aspect ratio of a pre-played image of the media source data in the first layer;
generating a transition animation based on the shared element image, and controlling the display to display the transition animation in the second layer;
controlling the display to display the first interface in the first layer after the transition animation display is completed, wherein the first interface presents a media source play image processed via an image quality processing corresponding to the image quality processing parameter.

2. The display apparatus according to claim 1, wherein the at least one processor is further configured to execute the computer instructions to cause the display apparatus to perform:
in response to a preview command input by a user for displaying the second interface, obtaining the media source data to be displayed in the second interface;
reading a first key-frame of the media source data to obtain the cover image;
based on an image view parameter of the second interface, cropping and/or scaling the cover image to generate the thumbnail icon of the media source data;
controlling the display to display the thumbnail icon of the media source data in the second interface.

3. The display apparatus according to claim 1, wherein the at least one processor is further configured to execute the computer instructions to cause the display apparatus to perform:
detecting a play mode of the media source data on the display apparatus; wherein the play mode comprises a full-screen scaling mode, an original scale mode, and an original size mode;
based on that the play mode is the full-screen scaling mode, obtaining screen size information of the display and generating an image display parameter based on the screen size information;
based on that the play mode is the original scale mode, obtaining image size information of the media source data, determining a scaling reference, and generating an image display parameter based on the image size information and the scaling reference; wherein the scaling reference is a screen width of the display or a screen height of the display;
based on that the play mode is the original size mode, obtaining image size information of the media source data, and generating an image display parameter based on the image size information.

4. The display apparatus according to claim 3, wherein the at least one processor is further configured to execute the computer instructions to cause the display apparatus to determine the scaling reference in the original scale mode by:
obtaining the image size information of the media source data and the screen size information of the display, wherein the image size information comprises an image width and an image height;
the screen size information comprises the screen width and the screen height;
calculating an image aspect ratio and a screen aspect ratio, wherein the image aspect ratio is a ratio of the image width to the image height; the screen aspect ratio is a ratio of the screen width to the screen height;
based on that the image aspect ratio is smaller than the screen aspect ratio, determining the scaling reference as the screen width, and generating the image display parameter based on the screen width and the image size information;
based on that the image aspect ratio is greater than the screen aspect ratio, determining the scaling reference as the screen height, and generating the image display parameter based on the screen height and the image size information.

5. The display apparatus according to claim 4, wherein the image display parameter comprises an image width of the shared element image and an image height of the shared element image, and the at least one processor is further configured to execute the computer instructions to cause the display apparatus to perform:
based on that the image aspect ratio is smaller than the screen aspect ratio, using the screen width as the image width, and calculating the image height of the shared element image based on the screen width and the image aspect ratio; wherein the image height of the shared element image is a ratio of the screen width to the image aspect ratio;
based on that the image aspect ratio is greater than the screen aspect ratio, using the screen height as the image height, and calculating the image width of the shared element image based on the screen height and the image aspect ratio; wherein the image height of the shared element image is a product of the screen width and the image aspect ratio.

6. The display apparatus according to claim 1, wherein the at least one processor is further configured to execute the computer instructions to cause the display apparatus to generate the shared element image based on the play status information and the first animation image by:
obtaining the first animation image, wherein the first animation image is the thumbnail icon of the media source data read from the memory or the cover image associated with the media source data which is loaded;
parsing an image display parameter from the play status information, wherein the image display parameter comprises an image width and an image height;
cropping the first animation image based on the image display parameter to obtain the shared element image.

7. The display apparatus according to claim 1, wherein the at least one processor is further configured to execute the computer instructions to cause the display apparatus to generate the transition animation based on the shared element image by:
generating a plurality of consecutive transition frames based on a display position of the thumbnail icon of the media source data on the second interface and a full-screen display region of the media source play image on the first interface, wherein the plurality of consecutive transition frames gradually change from an initial size of the thumbnail icon to a full-screen size;
each of the plurality of consecutive transition frames comprises an image view;
setting the shared element image in image views of the plurality of consecutive transition frames, and setting a play duration for each of the plurality of consecutive transition frames to generate smooth scaled transition animation.

8. The display apparatus according to claim 1, wherein the at least one processor is further configured to execute the computer instructions to cause the display apparatus to perform:
in response to a display command input by a user for displaying the second interface, obtaining the image quality processing parameter of the first layer, wherein the image quality processing parameter refers to a set of parameters generated based on configuration information of the display apparatus and a current image quality mode of the display apparatus;
performing an image quality processing on a thumbnail image to be displayed in the second interface based on the image quality processing parameter to generate a pre-processed preview image;
controlling the display to display the pre-processed preview image in the second layer as the thumbnail icon of the media source data.

9. The display apparatus according to claim 8, wherein the image quality processing parameter comprises a color matrix, wherein the color matrix is used for performing the image quality processing on the thumbnail image to be displayed in the second layer; and the color matrix is a parameter matrix composed of a product of image quality parameters of the first layer and a preset conversion coefficient.

10. The display apparatus according to claim 9, wherein the at least one processor is further configured to execute the computer instructions to cause the display apparatus to perform:
obtaining the configuration information of the display apparatus and the current image quality mode of the display apparatus;
extracting image quality gain parameters of the first layer under the current image quality mode; wherein the image quality gain parameters comprise at least one of: brightness, contrast, saturation, color temperature, or hue;
obtaining the preset conversion coefficient based on the configuration information and the current image quality mode; wherein the preset conversion coefficient is pre-calibrated by comparing display effects of a same image in the first layer and the second layer;
calculating a product of the preset conversion coefficient and the image quality gain parameters to generate the color matrix.

11. The display apparatus according to claim 8, wherein the at least one processor is further configured to execute the computer instructions to cause the display apparatus to perform:
in response to a setting command input by a user for modifying an image quality mode, controlling the display to display an image quality setting interface and calling the image quality processing parameter;
detecting an interaction action input by the user on the image quality setting interface to generate a new image quality parameter;
replacing the image processing parameter with the new image quality parameter and saving replaced image quality processing parameter;
updating all displayed thumbnail icons and ongoing transition animations in real-time using the replaced image quality processing parameter.

12. The display apparatus according to claim 8, wherein, before obtaining the image quality processing parameter of the first layer, the at least one processor is further configured to execute the computer instructions to cause the display apparatus to perform:
obtaining a configuration file of the second interface;
reading a key field used to characterize an image to be displayed in the configuration file;
based on that the key field is read in the configuration file and a parameter value of the key field is not null, obtaining the image quality processing parameter of the first layer;
based on that the key field is not read in the configuration file, or the parameter value of the key field is null, controlling the display to display the second interface.

13. The display apparatus according to claim 8, wherein the at least one processor is further configured to execute the computer instructions to cause the display apparatus to perform:
maintaining a visibility of the second layer throughout an entire play duration of the transition animation;
only after a final frame of the transition animation is rendered and displayed, fully displaying the first layer.

14. The display apparatus according to claim 1, wherein the at least one processor is further configured to execute the computer instructions to cause the display apparatus to perform:
based on that the first interface is displayed in the first layer on the display, in response to an exit command input by a user for stopping playing the media source data, obtaining icon shape information of the media source data on the second interface and the image quality processing parameter of the first layer;
generating the shared element image based on the icon shape information, the image quality processing parameter, and a second animation image, wherein the second animation image is an image obtained based on the display image content on the first interface; a shape of the shared element image is same as an icon shape of the media source data;
generating the transition animation based on the shared element image, and controlling the display to display the transition animation in the second layer;
after the transition animation display is completed, controlling the display to display the second interface in the second layer.

15. The display apparatus according to claim 14, wherein the at least one processor is further configured to execute the computer instructions to cause the display apparatus to perform:
parsing icon size information and an icon vertex shape from the icon shape information;
extracting a current frame image of the media source data from a frame buffer;
cropping a center region of the current frame image based on the icon size information and the icon vertex shape to obtain the shared element image.

16. The display apparatus according to claim 14, wherein the at least one processor is further configured to execute the computer instructions to cause the display apparatus to perform:
parsing icon size information and an icon vertex shape from the icon shape information;
extracting a current frame image of the media source data from a frame buffer;
cropping the current frame image based on the icon vertex shape and a proportional relationship between size parameters of the current frame image and the icon size information to obtain the shared element image.

17. The display apparatus according to claim 14, wherein the at least one processor is further configured to execute the computer instructions to cause the display apparatus to perform:
based on that the first interface is displayed in the first layer on the display, in response to the exit command input by the user on the first interface for stopping playing the media source data, obtaining the image quality processing parameter of the first layer; wherein the image quality processing parameter refers to a set of parameters generated based on configuration information of the display apparatus and a current image quality mode;
generating an animation image based on the displayed image content in the first layer;
performing an image quality processing on the animation image based on the image quality processing parameter to generate a second intermediate image;
generating the transition animation based on the second intermediate image, and controlling the display to display the transition animation in the second layer, so that a display effect of the transition animation is consistent with a display effect of the first interface.

18. The display apparatus according to claim 14, wherein the at least one processor is further configured to execute the computer instructions to cause the display apparatus to perform:
in response to a scaling command input by a user on the first interface for scaling a playing image in the first interface, obtaining the image quality processing parameter of the first layer and an image to be scaled, wherein the image quality processing parameter refers to a set of parameters generated based on configuration information of the display apparatus and a current image quality mode;
performing an image quality processing on the image to be scaled based on the image quality processing parameter, and performing scaling on the image to be scaled after the image quality processing to generate a scaled result image;
controlling the display to display the scaled result image in the second layer, so that a display effect of the scaled result image is consistent with a display effect of the first interface.

19. An animation display method for a display apparatus, wherein the display apparatus comprises a display configured to display a first layer and a second layer, the first layer is a video layer configured to display a first interface presenting a media source play image processed via an image quality processing, and the second layer is an On Screen Display (OSD) layer configured to display a second interface presenting a media source icon image; different image quality processings are performed on displayed image content in the first layer and displayed image content in the second layer; wherein the method comprises:
based on that the second interface is displayed in the second layer on the display, in response to a play command input by a user for playing media source data, obtaining play status information; wherein the play status information comprises an image quality processing parameter of the first layer;
generating a shared element image based on the play status information and a first animation image, wherein the first animation image is a thumbnail icon of the media source data or a cover image associated with the media source data; and an aspect ratio of the shared element image is equal to an aspect ratio of a pre-played image of the media source data in the first layer;
generating a transition animation based on the shared element image, and controlling the display to display the transition animation in the second layer;
controlling the display to display the first interface in the first layer after the transition animation display is completed, wherein the first interface presents a media source play image processed via an image quality processing corresponding to the image quality processing parameter.

20. The method according to claim 19, further comprising:
generating a plurality of consecutive transition frames based on a display position of the thumbnail icon of the media source data on the second interface and a full screen display region of the media source play image on the first interface, wherein the plurality of consecutive transition frames gradually change from an initial size of the thumbnail icon to a full screen size; each of the plurality of consecutive transition frames comprises an image view;
setting the shared element image in image views of the plurality of consecutive transition frames, and setting a play duration for each of the plurality of consecutive transition frames to generate smooth scaled transition animation.
